(19) United States
(12) Patent Application Publication
(10) Pub. No.: US 2026/0357859 A1
(43) Pub. Date: Nov. 12, 2026

(54) OPPOSED PISTON-TYPE DISC BRAKE DEVICE

(71) Applicant: AKEBONO BRAKE INDUSTRY CO., LTD., Chuo-ku, Tokyo (JP)

(72) Inventor: Yu KASHIWAZAKI, Tokyo (JP)

(73) Assignee: AKEBONO BRAKE INDUSTRY CO., LTD., Chuo-ku, Tokyo (JP)

(21) Appl. No.: 19/132,994

(22) PCT Filed: Dec. 15, 2023
(86) PCT No.: PCT/JP2023/045160

§ 371 Date: May 27, 2025

(30) Foreign Application Priority Data
Dec. 23, 2022 (JP) 2022-206729

(51) Int. Cl. F16D 65/00; F16D 55/00; F16D 55/226

(52) U.S. Cl. CPC F16D 65/0056; F16D 55/226; F16D 2055/0008

(57) ABSTRACT

In an opposed piston-type disc brake device, a pad clip has a substantially rectangular C-shape when viewed in an axial direction, and includes a base portion that is fitted into a guide concave groove to surround a lug portion, a resilient portion that has an end portion on one side connected to the base portion and that is disposed on a circumferential outer side of the base portion in the guide concave groove, and a pressing portion that extends toward a circumferential inner side from an end portion on the other side of the resilient portion and that is configured to press a pad in a direction away from a rotor in the axial direction by an elastic force of the resilient portion.

### TECHNICAL FIELD

The present invention relates to an opposed piston-type disc brake device.

### BACKGROUND ART

The disc brake devices are widely used because the disc brake devices have excellent heat dissipation properties and allow for fine adjustment of braking force during driving.

The disc brake device generates a braking force by pressing a pair of pads, which are disposed on both axial sides of a rotor that rotates together with the wheel, against both axial side surfaces of the rotor by a piston. When braking is released, the elastic restoring force of the piston seal pulls the piston back to the deep side of the cylinder, and the axial side surface of the rotor that is rotating and wobbling presses the pad in a direction away from the rotor. Accordingly, the pads are separated from the rotor, and a clearance is ensured between the pads and the rotor.

Unless otherwise specified, the axial direction, radial direction, and circumferential direction refer to the axial direction, radial direction, and circumferential direction of the rotor.

When the pads are pressed by the axial side surface of the rotor, the pads may not move smoothly in the direction away from the rotor and may be tilted. When the pads are tilted in this manner, the pads cannot be sufficiently separated from the rotor, and dragging between the pads and the rotor can become a problem.

In view of these circumstances, it has been considered to incorporate a pad clip into the disc brake device, and to separate the pads from the rotor by utilizing the elastic force of the pad clip when braking is released.

WO2014/097098A1 (Patent Literature 1) discloses a structure for an opposed piston-type disc brake device in which a pad clip disposed on the radial outer side of the pad is utilized to separate the pad from the rotor when braking is released. Specifically, a part of the pad clip that presses the outer circumferential edge portion of the pad is made into a tapered surface, and accordingly, the pad is pressed toward the radial inner side and is also pressed in the direction away from the rotor in the axial direction.

JP2016-28216A (Patent Literature 2) discloses a structure for a floating-type disc brake device in which a pad clip fixed to the back surface of the pad is utilized to separate the pad from the rotor when braking is released. Specifically, a pad clip having an approximately rectangular C-shape when viewed in the radial direction is disposed on the back surface side of the pad, the end portion on one side of the pad clip is fixed to the back surface of the pad, and the end portion on the other side of the pad clip is abutted against a surface facing in the direction opposite to the rotor in the axial direction in the support. In this manner, the elastic force of the pad clip, which is elastically deformed during braking, is utilized to pull the pad in the direction away from the rotor when braking is released.

### CITATION LIST

### Patent Literature

Patent Literature 1: WO2014/097098A1

Patent Literature 2: JP2016-28216A

### SUMMARY OF INVENTION

### Technical Problem

The structure described in WO2014/097098A1 presses the pad in the axial direction using a component force by utilizing the tapered surface of the pad clip, which results in insufficient pressing force in the axial direction, making it difficult to sufficiently separate the pad from the rotor.

In contrast, the structure described in JP2016-28216A can apply a sufficient tensile force to the pad to separate the pad from the rotor. However, because the pad clip needs to be disposed on the back surface side of the pad, it is difficult to adopt this in a structure, such as an opposed piston-type disc brake device, in which the caliper body is disposed close to the back surface side of the pad and a space cannot be ensured for disposing the pad clip on the back surface side of the pad.

The present invention has been made to solve the above-mentioned problems, and an object thereof is to provide an opposed piston-type disc brake device in which a pad clip can be disposed without interfering with other members, and in which the pad clip can apply a sufficient pressing force in the axial direction to the pad to separate the pad from the rotor.

### Solution to Problem

An opposed piston-type disc brake device according to one aspect of the present invention includes a caliper, a pad, and a pad clip.

The caliper has two or more cylinders and is configured to be fixed to a suspension device.

The pad is supported to be movable in an axial direction with respect to the caliper.

The pad clip is made of a metal plate, and is disposed between the caliper and the pad.

The caliper includes a guide wall portion at a part adjacent to a circumferential outer side of the pad, the guide wall portion having a circumferential side surface facing the pad in a circumferential direction and an axial side surface facing a rotor in the axial direction, respectively.

The guide wall portion includes a guide concave groove extending in the circumferential direction and having a circumferential opening portion opening on the circumferential side surface and an axial opening portion opening on the axial side surface, respectively.

The pad includes a lug portion that is configured to be engaged in the axial direction with the guide concave groove to be movable.

The pad clip has a substantially rectangular C-shape when viewed in the axial direction, and includes a base portion that is fitted into the guide concave groove to surround the lug portion, a resilient portion that has an end portion on one side connected to the base portion and that is disposed on the circumferential outer side of the base portion in the guide concave groove, and a pressing portion that extends toward a circumferential inner side from an end portion on the other side of the resilient portion and that is configured to press the pad in a direction away from the rotor in the axial direction by an elastic force of the resilient portion.

In the opposed piston-type disc brake device according to the aspect of the present invention, the resilient portion may be configured in a partial cylindrical shape (semi-cylindrical, semi-long cylindrical, and semi-elliptical cylindrical shapes) that is substantially C-shaped (including U-shaped) when viewed in a radial direction.

Otherwise, the resilient portion may be configured in a substantially J-shape, a substantially V-shape, a substantially M-shape, or the like when viewed in the radial direction.

In the opposed piston-type disc brake device according to the aspect of the present invention, the base portion may have an outer circumferential side plate portion disposed along an outer circumferential wall surface facing a radial inner side in the guide concave groove, an inner circumferential side plate portion disposed along an inner circumferential wall surface facing a radial outer side in the guide concave groove, and a connecting plate portion connecting end portions on the circumferential outer sides of each of the outer circumferential side plate portion and the inner circumferential side plate portion, and the end portion on one side of the resilient portion may be connected to an end portion on a side farther from the rotor (opposite-rotor side) in the axial direction in the connecting plate portion.

In the opposed piston-type disc brake device according to the aspect of the present invention, the end portion on the side farther from the rotor in the axial direction in the connecting plate portion may be disposed closer to the rotor side than the end portion on the side farther from the rotor in the axial direction on the outer circumferential side plate portion and the inner circumferential side plate portion.

In this case, the end portion on one side of the resilient portion may be disposed closer to the rotor side than the end portion on the side farther from the rotor in the axial direction in the outer circumferential side plate portion and the inner circumferential side plate portion.

In the opposed piston-type disc brake device according to the aspect of the present invention, the pad clip may further include an outwardly bent plate portion bent toward the radial outer side from the end portion on the circumferential inner side of the outer circumferential side plate portion, and an inwardly bent plate portion bent toward the radial inner side from the end portion on the circumferential inner side of the inner circumferential side plate portion.

Otherwise, in the opposed piston-type disc brake device according to the aspect of the present invention, it is possible to have only one of the outwardly bent plate portion and the inwardly bent plate portion, or it is possible to have neither the outwardly bent plate portion nor the inwardly bent plate portion.

In the opposed piston-type disc brake device according to the aspect of the present invention, the outwardly bent plate portion may be folded at a right angle with respect to the outer circumferential side plate portion, and the inwardly bent plate portion may be folded at a right angle with respect to the inner circumferential side plate portion. Otherwise, the bending angle of the outwardly bent plate portion with respect to the outer circumferential side plate portion and the bending angle of the inwardly bent plate portion with respect to the inner circumferential side plate portion may be made different from each other.

Furthermore, the outwardly bent plate portion and the inwardly bent plate portion may be disposed at the same circumferential position, or may be disposed offset from each other in the circumferential direction.

In the opposed piston-type disc brake device according to the aspect of the present invention, an outer circumferential groove extending in the circumferential direction may be provided on the outer circumferential wall surface of the guide concave groove, and a claw portion that is configured to be engaged with the outer circumferential groove may be provided on the outer circumferential side plate portion. Otherwise, an outer radial groove extending in the radial direction may be provided at a radial outer side part of the circumferential opening portion of the guide concave groove on the circumferential side surface of the guide wall portion, and a claw portion that is configured to be engaged with the outer radial groove may be provided on the outwardly bent plate portion.

In the opposed piston-type disc brake device according to the aspect of the present invention, the outer circumferential groove may extend linearly in the circumferential direction and the axial position may not change regardless of circumferential position, or may be inclined in the direction toward the rotor or opposite-rotor side in the axial direction as moving toward the circumferential outer side. In addition, the groove width and groove depth of the outer circumferential groove may be constant over the entire length in the circumferential direction, or may be made different depending on the circumferential position.

In the opposed piston-type disc brake device according to the aspect of the present invention, the outer radial groove may extend linearly in the radial direction and the axial position may not change regardless of radial position, or may be inclined in the direction toward the rotor or opposite-rotor side in the axial direction as moving toward the radial outer side. In addition, the groove width and groove depth of the outer radial groove may be constant over the entire length in the radial direction, or may be made different depending on the radial position.

In the opposed piston-type disc brake device according to the aspect of the present invention, an inner circumferential groove extending in the circumferential direction may be provided on the inner circumferential wall surface of the guide concave groove, and a claw portion that is configured to be engaged with the inner circumferential groove may be provided on the inner circumferential side plate portion. Otherwise, an inner radial groove extending in the radial direction may be provided at a radial inner side part of the circumferential opening portion of the guide concave groove on the circumferential side surface of the guide wall portion, and a claw portion that is configured to be engaged with the inner radial groove may be provided on the inwardly bent plate portion.

In the opposed piston-type disc brake device according to the aspect of the present invention, the inner circumferential groove may extend linearly in the circumferential direction and the axial position may not change regardless of circumferential position, or may be inclined in the direction toward the rotor or opposite-rotor side in the axial direction as moving toward the circumferential outer side. In addition, the groove width and groove depth of the inner circumferential groove may be constant over the entire length in the circumferential direction, or may be made different depending on the circumferential position.

In the opposed piston-type disc brake device according to the aspect of the present invention, the inner radial groove may extend linearly in the radial direction and the axial position may not change regardless of radial position, or may be inclined in the direction toward the rotor or opposite-rotor side in the axial direction as moving toward the radial inner side. In addition, the groove width and groove depth of the inner radial groove may be constant over the entire length in the radial direction, or may be made different depending on the radial position.

In the opposed piston-type disc brake device according to the aspect of the present invention, an outer radial groove extending in the radial direction may be provided at the radial outer side part of the circumferential opening portion of the guide concave groove on the circumferential side surface of the guide wall portion, and a claw portion that is configured to be engaged with the outer radial groove may be provided on the outwardly bent plate portion.

In addition, an inner circumferential groove extending in the circumferential direction may be provided on the inner circumferential wall surface of the guide concave groove, and a claw portion that is configured to be engaged with the inner circumferential groove may be provided on the inner circumferential side plate portion.

In the opposed piston-type disc brake device according to the aspect of the present invention, an outer radial groove extending in the radial direction may be provided at the radial outer side part of the circumferential opening portion of the guide concave groove on the circumferential side surface of the guide wall portion, and a claw portion that is configured to be engaged with the outer radial groove may be provided on the outwardly bent plate portion.

In addition, an inner radial groove extending in the radial direction may be provided at a radial inner side part of the circumferential opening portion of the guide concave groove on the circumferential side surface of the guide wall portion, and a claw portion that is configured to be engaged with the inner radial groove may be provided on the inwardly bent plate portion.

Note that the groove bottom surface of the outer radial groove and the groove bottom surface of the inner radial groove may be disposed on the same imaginary cylindrical surface.

In the opposed piston-type disc brake device according to the aspect of the present invention, the connecting plate portion may have a notch at an end portion on a side closer to the rotor in the axial direction, and a part of the resilient portion or a part of the pressing portion may be disposed on an inner side of the notch.

In the opposed piston-type disc brake device according to the aspect of the present invention, at least one of the inwardly bent plate portion and the outwardly bent plate portion may have a pressure receiving portion that is configured to receive a torque acting on the pad during braking.

When the inwardly bent plate portion includes both the claw portion and the pressure receiving portion, the pressure receiving portion may be disposed on the radial inner side of the claw portion.

When the outwardly bent plate portion includes both the claw portion and the pressure receiving portion, the pressure receiving portion may be disposed on the radial outer side of the claw portion.

In the opposed piston-type disc brake device according to the aspect of the present invention, each of the resilient portion and the pressing portion may not protrude from the axial opening portion of the guide concave groove to a side of the rotor in the axial direction.

In the opposed piston-type disc brake device according to the aspect of the present invention, the resilient portion may include a cutout portion.

The cutout portion may have a function of relieving the stress acting on the resilient portion, and may be, for example, a slit formed at the intermediate portion in the width direction of the resilient portion, or a notch formed at end portions on both sides in the width direction of the resilient portion.

In the opposed piston-type disc brake device according to the aspect of the present invention, the pressing portion may be configured to press an axial side surface of the lug portion of the pad.

In the opposed piston-type disc brake device according to the aspect of the present invention, a bent portion in which a surface on an opposite side of the rotor in the axial direction is a convex surface may be provided at the end portion on the circumferential inner side of the pressing portion.

### Advantageous Effects of Invention

According to one aspect of the opposed piston-type disc brake device of the present invention, the pad clip can be disposed without interfering with other members, and the pad clip can apply a sufficient pressing force in the axial direction to the pad to separate the pad from the rotor.

### BRIEF DESCRIPTION OF DRAWINGS

FIG. 1 is a front view illustrating a disc brake device according to a first example of an embodiment.

FIG. 2 is a plan view illustrating the disc brake device according to the first example of the embodiment.

FIG. 3 is a side view of the disc brake device according to the first example of the embodiment, when viewed from a rotation-in side.

FIG. 4 is a bottom view illustrating the disc brake device according to the first example of the embodiment.

FIG. 5 is a perspective view of the disc brake device according to the first example of the embodiment, when viewed from a radial outer side and the rotation-in side.

FIG. 6 is a perspective view of the disc brake device according to the first example of the embodiment, when viewed from a radial inner side and a rotation-out side.

FIG. 7 is a cross-sectional view of line A-A in FIG. 2.

FIG. 8 is a partially enlarged view of FIG. 7.

FIG. 9 is a schematic cross-sectional view of line B-B in FIG. 8.

FIG. 10 is a diagram in which an inner pad and a pad clip are omitted from FIG. 7.

FIG. 11 (A) of FIG. 11 is a perspective view of a guide wall portion provided on the rotation-out side of an inner body for the first example of the embodiment, when viewed from the circumferential inner side, and (B) of FIG. 11 is a perspective view illustrating a state where the pad clip is mounted in the guide concave groove of the guide wall portion of (A) of FIG. 11.

FIG. 12 is a front view illustrating the inner pad removed from the disc brake device according to the first example of the embodiment.

FIG. 13 is a front view illustrating the inner pad and the pad clip removed from the disc brake device according to the first example of the embodiment.

FIG. 14 is a cross-sectional view of line C-C in FIG. 13.

FIG. 15 is a view illustrating the pad clips disposed on an axial inner side and the rotation-out side that are removed from the disc brake device according to the first example of the embodiment, where (A) of FIG. 15 is a front view, (B) of FIG. 15 is a plan view, (C) of FIG. 15 is a bottom view, (D) of FIG. 15 is a right side view, and (E) of FIG. 15 is a left side view.

FIG. 16 is a perspective view of the pad clips disposed on the axial inner side and the rotation-out side that are removed from the disc brake device according to the first example of the embodiment, when viewed from four directions on the axial outer side. FIG. 17 is a perspective view of the pad clips disposed on the axial inner side and the rotation-out side that are removed from the disc brake device according to the first example of the embodiment, when viewed from four directions on the axial inner side.

FIG. 18 is a view corresponding to FIG. 11, illustrating a second example of the embodiment.

FIG. 19 is a perspective view of the guide wall portion and the pad clip of (B) of FIG. 18 for the second example of the embodiment, when viewed from the radial inner side.

FIG. 20 is a view corresponding to FIG. 11, illustrating a third example of the embodiment.

FIG. 21 is a view corresponding to FIG. 11, illustrating a fourth example of the embodiment.

FIG. 22 is a schematic view of a part of the guide wall portion provided on the rotation-out side of the inner body for the fourth example of the embodiment, when viewed from the axial outer side.

FIG. 23 (A) of FIG. 23 is a perspective view illustrating a state where the pad clip is mounted in the guide concave groove of the guide wall portion provided on the rotation-out side of the inner body, for a fifth example of the embodiment, and (B) of FIG. 23 is a perspective view illustrating a state where a lug portion of the inner pad is engaged with the guide concave groove of (A) of FIG. 23.

### DESCRIPTION OF EMBODIMENTS

### First Example of Embodiment

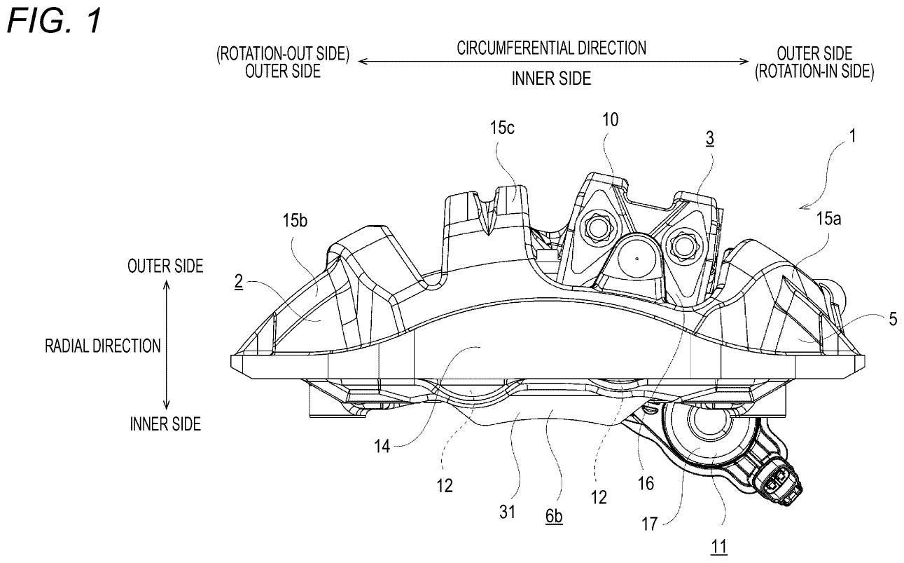

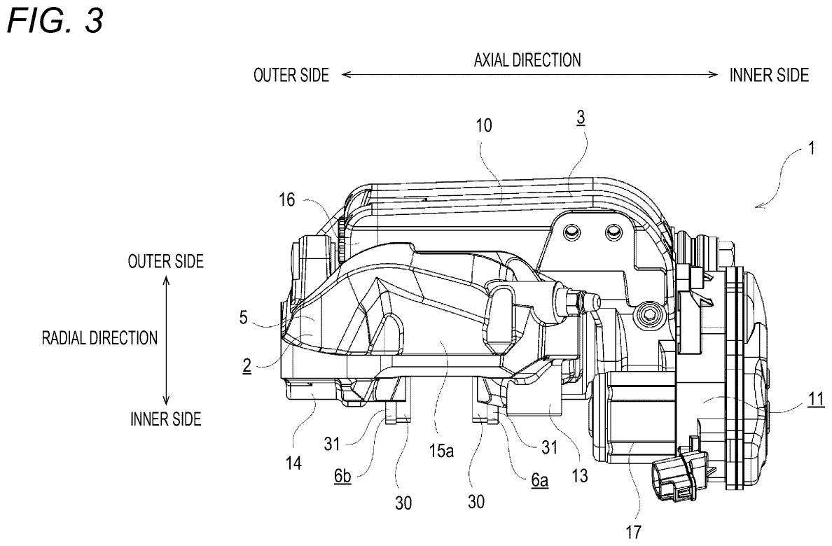

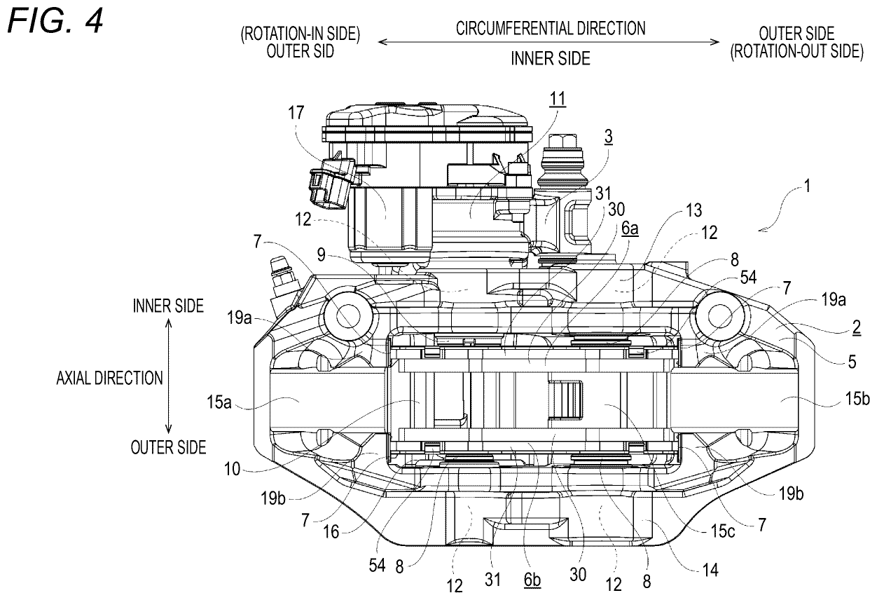

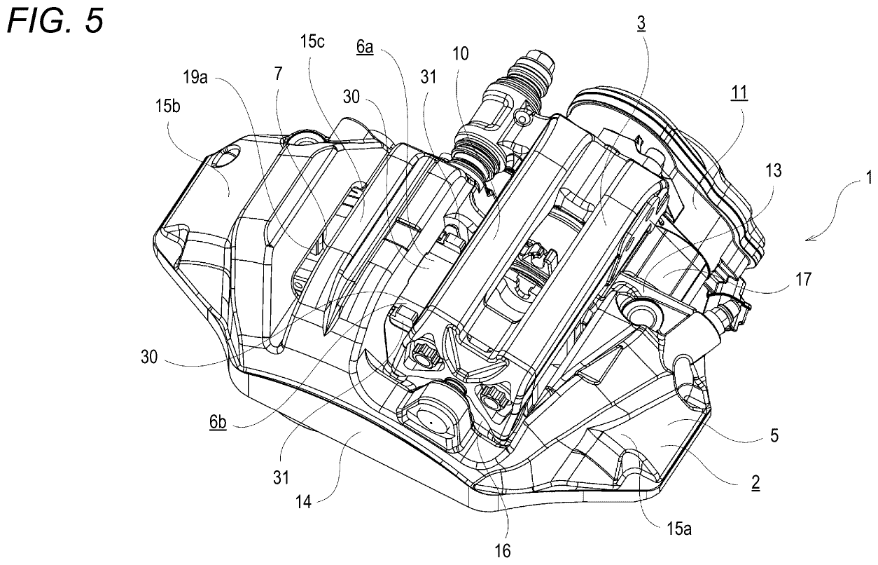

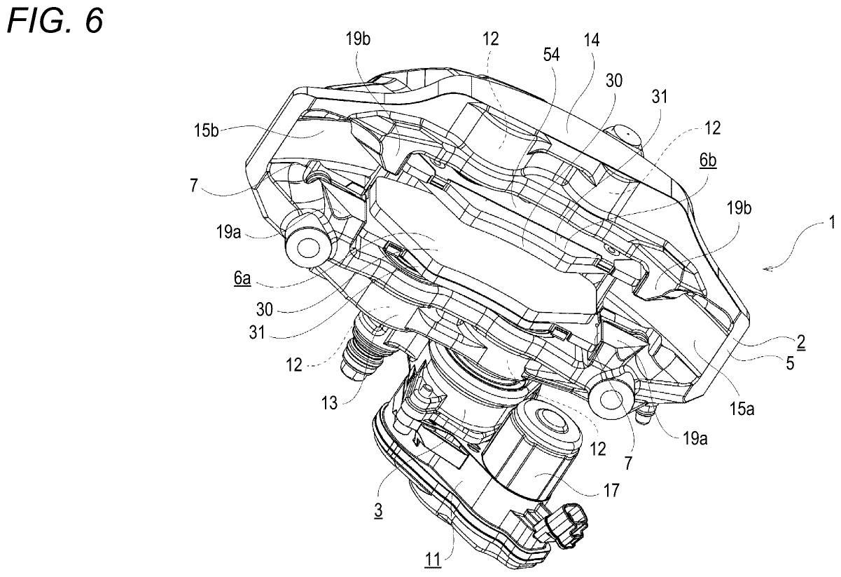

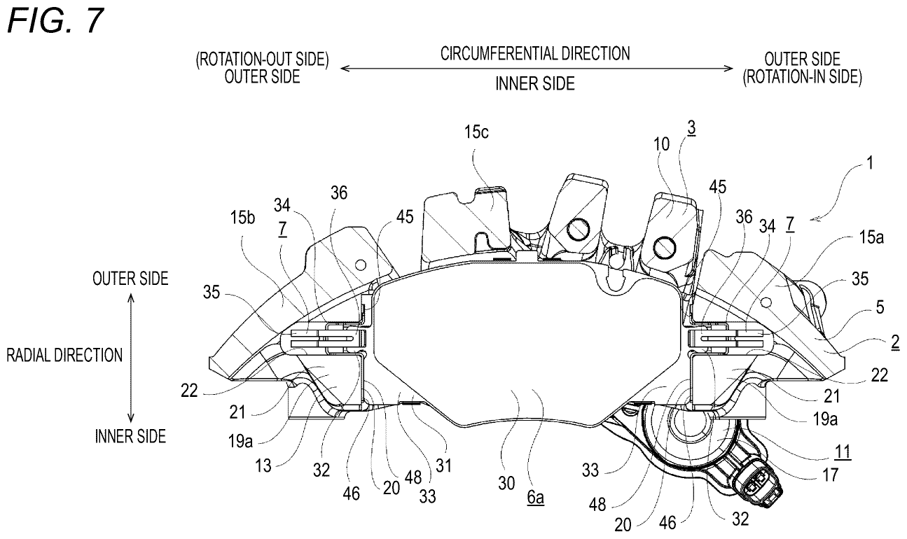

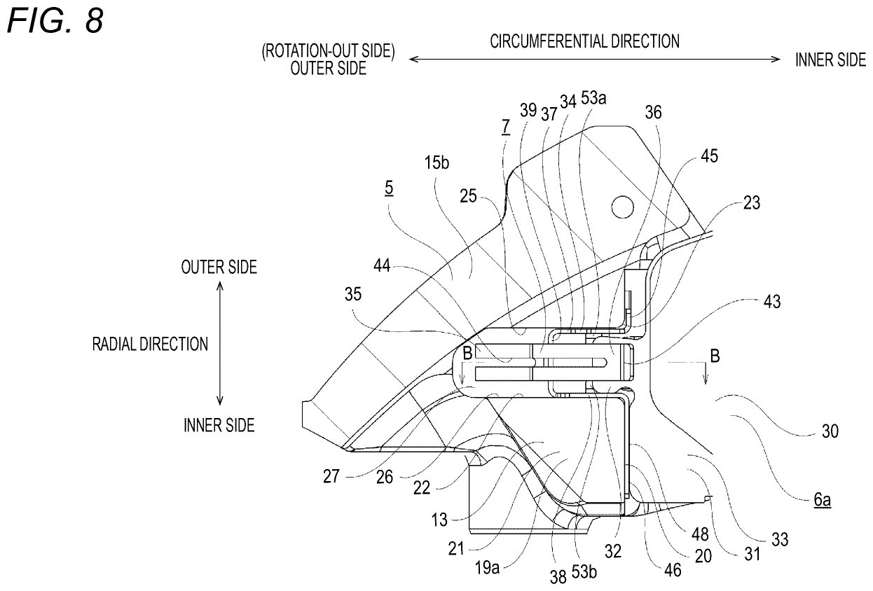

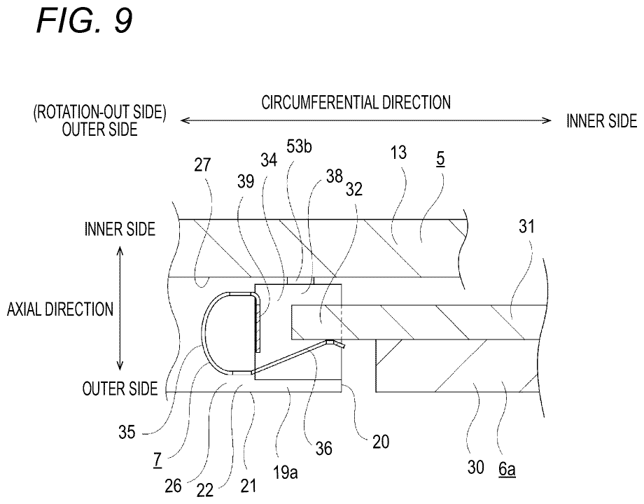

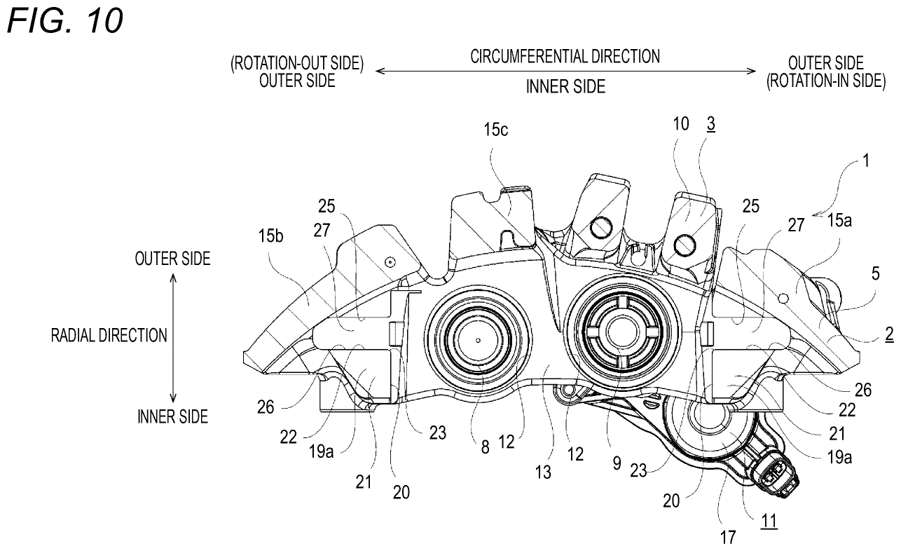

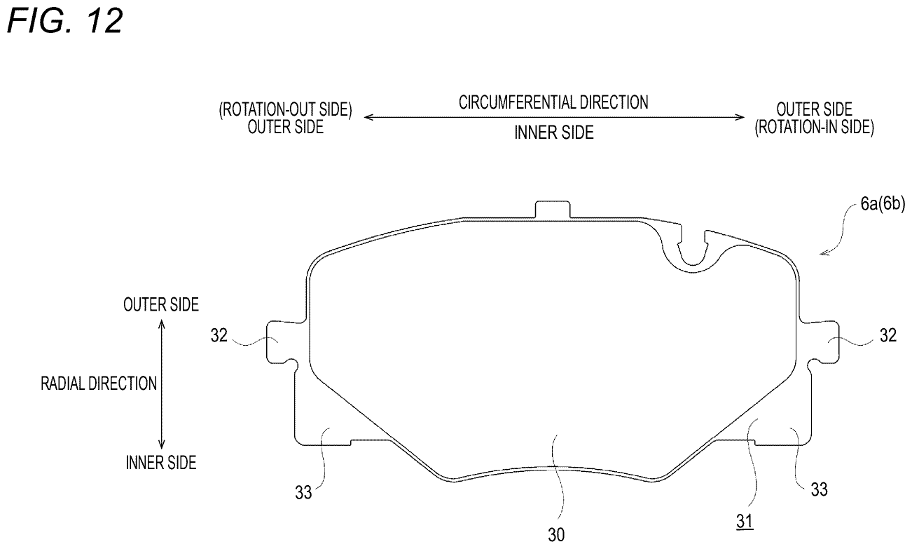

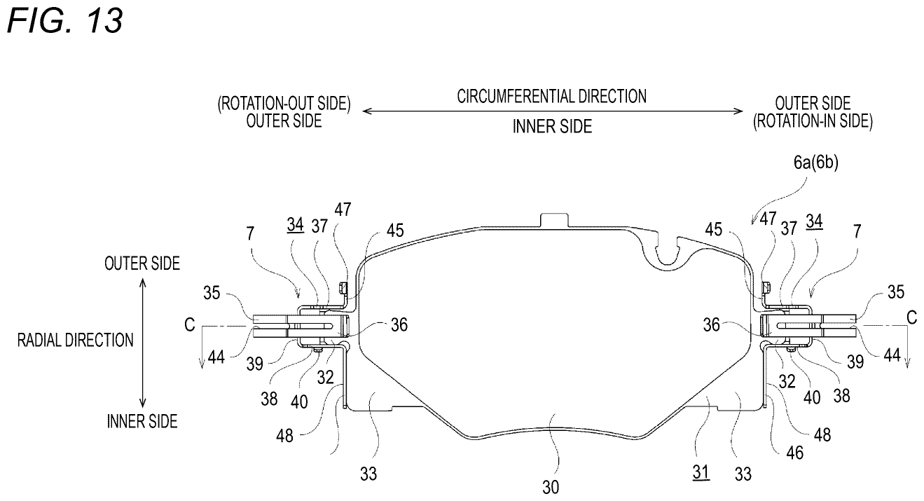

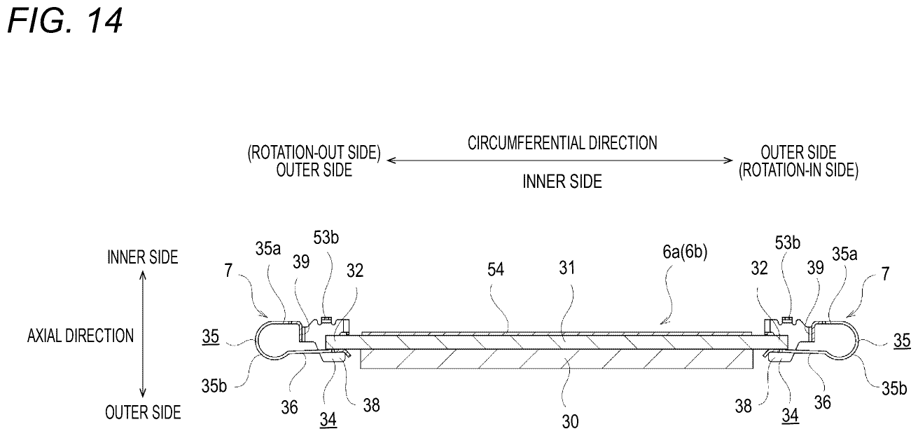

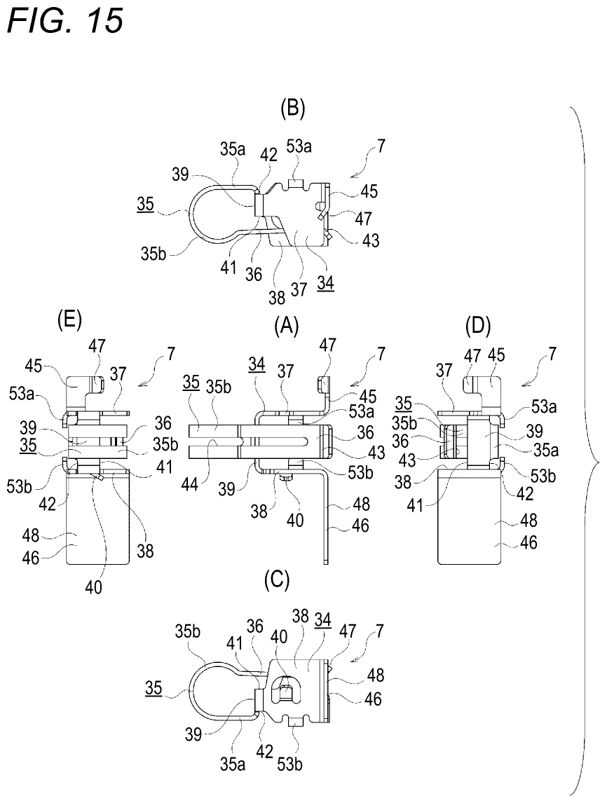

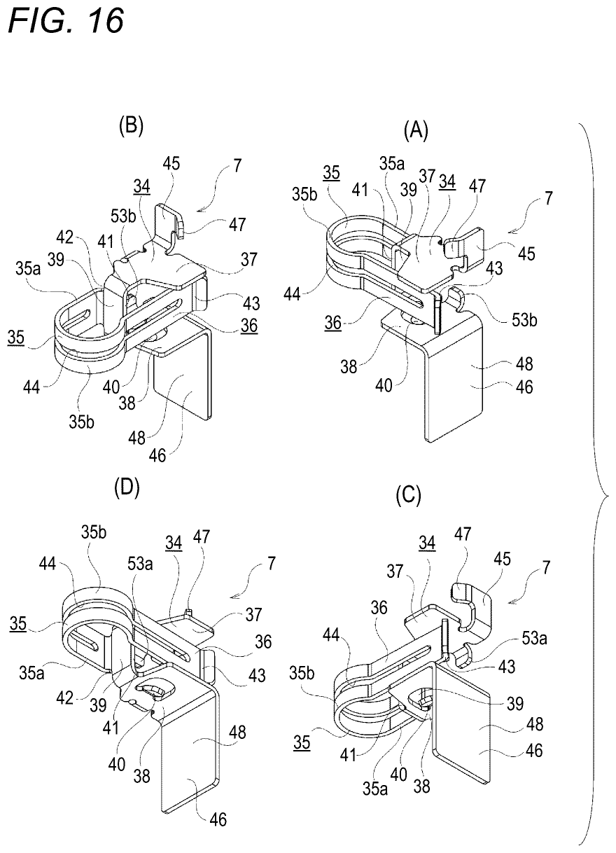

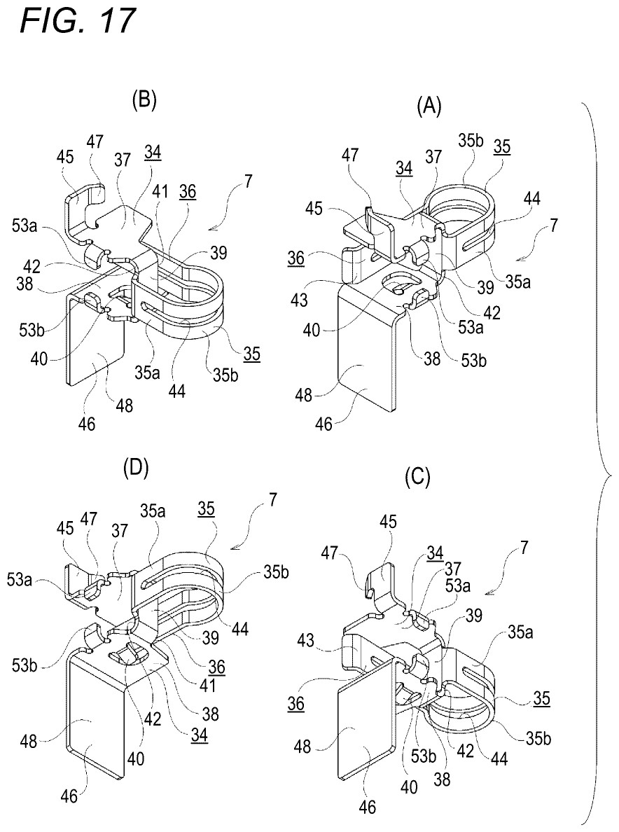

A first example of the embodiment will be described with reference to FIGS. 1 to 17.

The opposed piston-type disc brake device 1 of this example is a hybrid type disc brake device in which a hydraulic opposed piston-type brake mechanism portion 2 that functions as a service brake is combined with an electric floating-type brake mechanism portion 3 that functions as a parking brake. However, the present invention is also applicable to opposed piston-type disc brake devices that are widely known in the art and do not include a floating-type brake mechanism portion.

The overall structure of the disc brake device 1 of this example will be described below, and then the pad clip 7 and the surrounding structure thereof will be described in detail.

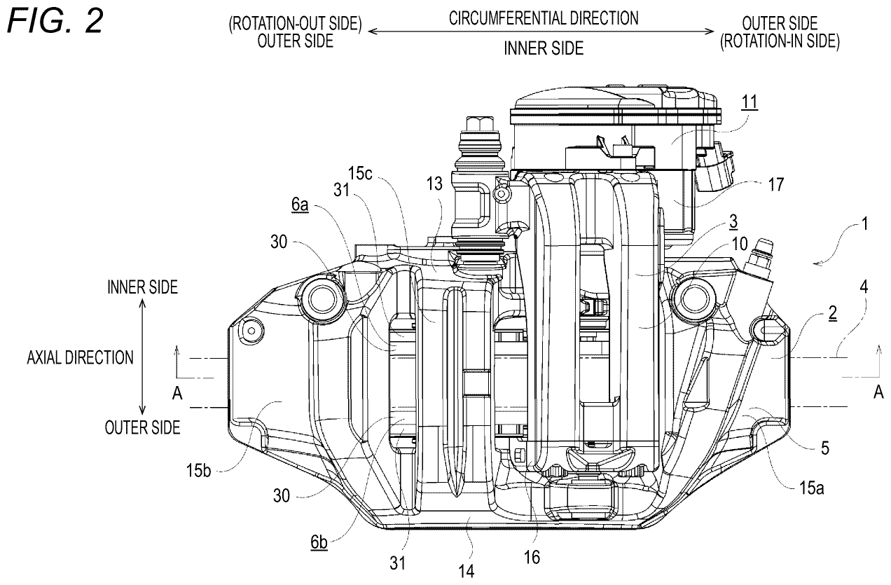

In this specification and claims, unless otherwise specified, the axial direction, circumferential direction, and radial direction refer to the axial direction, circumferential direction, and radial direction of a disk-shaped rotor 4 (refer to FIG. 2) that rotates together with the wheel. Additionally, the axial inner side refers to the center side in the width direction of the vehicle in a state of being assembled to the vehicle, and the axial outer side refers to the outer side in the width direction of the vehicle in a state of being assembled to the vehicle. Additionally, the circumferential inner side refers to the circumferential center side of the disc brake device 1, and the circumferential outer side refers to both circumferential sides of the disc brake device 1. In addition, the rotation-in side refers to the side on the circumferential outer side where the rotor 4 enters the inner side of the caliper 5 when the vehicle is moving forward, and the rotation-out side refers to the side on the circumferential outer side where the rotor 4 exits to the outer side of the caliper 5 when the vehicle is moving forward.

### Overall Structure of Disc Brake Device

The disc brake device 1 includes a caliper 5, a pair of pads 6a and 6b, and four pad clips 7.

The disc brake device 1 of this example further includes a plurality of pistons 8 and 9 (four in the illustrated example), a clamp member 10, and an electric actuator 11.

The caliper 5 is made of an aluminum-based alloy or an iron-based alloy, and has an overall boat-like shape. The caliper 5 forms the opposed piston-type brake mechanism portion 2 and is fixed to a suspension device such as a knuckle. The caliper 5 has a plurality of cylinders 12 (four in the illustrated example).

Specifically, the caliper 5 has an inner body 13 disposed on the axial inner side of the rotor 4 and an outer body 14 disposed on the axial outer side of the rotor 4, each of which has two cylinders 12. The two cylinders 12 provided in the inner body 13 and the two cylinders 12 provided in the outer body 14 are disposed coaxially with each other. The inner body 13 and the outer body 14 are connected to each other by a plurality of connecting portions 15a, 15b, and 15c (three in the illustrated example) that extend in the axial direction.

The pistons 8 and 9 are fitted in each of the cylinders 12 to be displaceable in the axial direction. Among the four cylinders 12 provided in the caliper 5, three cylinders 12 are fitted with service-only pistons 8 that operate only during braking by the service brake, and the remaining one cylinder 12 is fitted with a dual-purpose piston 9 that operates during braking by both the service brake and the parking brake. The dual-purpose piston 9 is fitted into the cylinder 12 that is disposed on the axial inner side and the rotation-in side among the four cylinders 12.

The pair of pads 6a and 6b are disposed on both axial sides of the rotor 4 and are supported to be movable in the axial direction with respect to the caliper 5. Specifically, the inner pad 6a disposed on the axial inner side of the rotor 4 is supported to be movable in the axial direction with respect to the inner body 13. An outer pad 6b disposed on the axial outer side of the rotor 4 is supported to be movable in the axial direction with respect to the outer body 14.

The pad clips 7 are made of metal plate and are disposed respectively at a part between the end portions on both circumferential outer sides of the inner pad 6a and the inner body 13, and a part between the end portions on both circumferential outer sides of the outer pad 6b and the outer body 14. The pad clip 7 has a function of holding the inner pad 6a and the outer pad 6b, respectively, preventing the inner pad 6a and the outer pad 6b from being seized to the caliper 5, and ensuring smooth movement in the axial direction of the inner pad 6a and the outer pad 6b.

The clamp member 10 forms the floating-type brake mechanism portion 3 and is supported to be movable in the axial direction with respect to the caliper 5 to straddle the pair of pads 6a and 6b from the radial outer side. The clamp member 10 has a claw portion 16 at the end portion on the axial outer side. The claw portion 16 is disposed between the axial outer side surface of the outer pad 6b and the axial inner side surface of the outer body 14 of the caliper 5, and presses the outer pad 6b toward the axial inner side during braking by the parking brake.

The electric actuator 11 includes: an electric drive unit (MGU) 17 fixed to the axial inner side of the clamp member 10; and a rotation-to-linear motion conversion mechanism (not illustrated) that is driven by the electric drive unit 17 and converts rotational motion into linear motion.

The disc brake device 1 of this example obtains a braking force by the service brakes by feeding brake oil, which is hydraulic fluid, to all of the cylinders 12 provided in the caliper 5. Specifically, brake oil is fed into all of the cylinders 12 to push all of the pistons 8 and 9 out of the cylinders 12. The rotor 4 is clamped from both axial sides by the pair of pads 6a and 6b, thereby obtaining a braking force by the service brake.

Furthermore, the disc brake device 1 of this example obtains a braking force by the parking brake by driving the electric actuator 11. Specifically, the rotation-to-linear motion conversion mechanism is driven by the electric drive unit 17 to push the dual-purpose piston 9 out of the cylinder 12 and press the inner pad 6a to the axial inner side surface of the rotor 4. Furthermore, the reaction force generated by the pressing causes the clamp member 10 to be displaced to the axial inner side with respect to the caliper 5, and the claw portions 16 press the outer pad 6b to the axial outer side surface of the rotor 4. As a result, the rotor 4 is clamped from both axial sides by the pair of pads 6a and 6b, and a braking force is generated by the parking brake.

In the disc brake device 1 of this example, when the braking forces of the service brake and the parking brake are released, the pad clip 7 separates the inner pad 6a and the outer pad 6b from the rotor 4 in the axial direction. Specifically, the inner pad 6a is pressed toward the axial inner side by two pad clips 7 disposed on the axial inner side, and the inner pad 6a is separated from the rotor 4. In addition, the outer pad 6b is pressed toward the axial outer side by two pad clips 7 disposed on the axial outer side, and the outer pad 6b is separated from the rotor 4.

Next, the pad clip 7 of this example and the surrounding structure thereof will be described in detail.

As described above, the pad clips 7 are disposed respectively at a part between the end portions on both circumferential outer sides of the inner pad 6a and the inner body 13, and a part between the end portions on both circumferential outer sides of the outer pad 6b and the outer body 14. Therefore, the structures of the inner body 13 and the outer body 14, and the structures of the inner pad 6a and the outer pad 6b as the surrounding structures of the pad clip 7 will be described in detail.

### Inner Body and Outer Body

The inner body 13 has guide wall portions 19a respectively at parts adjacent to both circumferential outer sides of the inner pad 6a. The guide wall portions 19a are provided on both circumferential outer side portions of the axial outer side surface of the inner body 13.

The outer body 14 has guide wall portions 19b respectively at parts adjacent to both circumferential outer sides of the outer pad 6b. The guide wall portions 19b are provided on both circumferential outer side portions of the axial inner side surface of the outer body 14.

The guide wall portions 19a and 19b each have a circumferential side surface 20 facing the inner pad 6a or the outer pad 6b in the circumferential direction, and an axial side surface 21 facing the rotor 4 in the axial direction. Specifically, the guide wall portion 19a provided on the inner body 13 has the circumferential side surface 20 facing the inner pad 6a in the circumferential direction, and the axial side surface 21 facing the axial inner side surface of the rotor 4 in the axial direction. In contrast, the guide wall portion 19b provided on the outer body 14 has the circumferential side surface 20 facing the outer pad 6b in the circumferential direction, and the axial side surface 21 facing the axial outer side surface of the rotor 4 in the axial direction.

Each of the circumferential side surface 20 and the axial side surface 21 is configured to be flat. The circumferential side surface 20 and the axial side surface 21 are disposed at approximately a right angle.

The guide wall portions 19a and 19b have a guide concave groove 22 extending in the circumferential direction at a radial intermediate portion. The guide concave groove 22 is formed by utilizing a cutting tool such as a milling cutter. The guide concave groove 22 is a rectangular groove having a rectangular shape in a cross section perpendicular to the axial side surface 21, and has a circumferential opening portion 23 that opens into the circumferential side surface 20 of the guide wall portions 19a and 19b, and an axial opening portion 24 that opens into the axial side surface 21 of the guide wall portions 19a and 19b. The guide concave grooves 22 are provided to support lug portions 32 (to be described later) provided on the inner pad 6a and the outer pad 6b to be movable in the axial direction.

The groove width in the radial direction of the guide concave groove 22 is substantially constant in the circumferential direction. In addition, the groove depth in the axial direction of the guide concave groove 22 is substantially constant in the circumferential direction.

The guide concave groove 22 has a flat outer circumferential wall surface 25 facing the radial inner side, and a flat inner circumferential wall surface 26 facing the radial outer side. The outer circumferential wall surface 25 and the inner circumferential wall surface 26 are disposed substantially parallel to each other. Further, the guide concave groove 22 has a flat axial bottom surface 27.

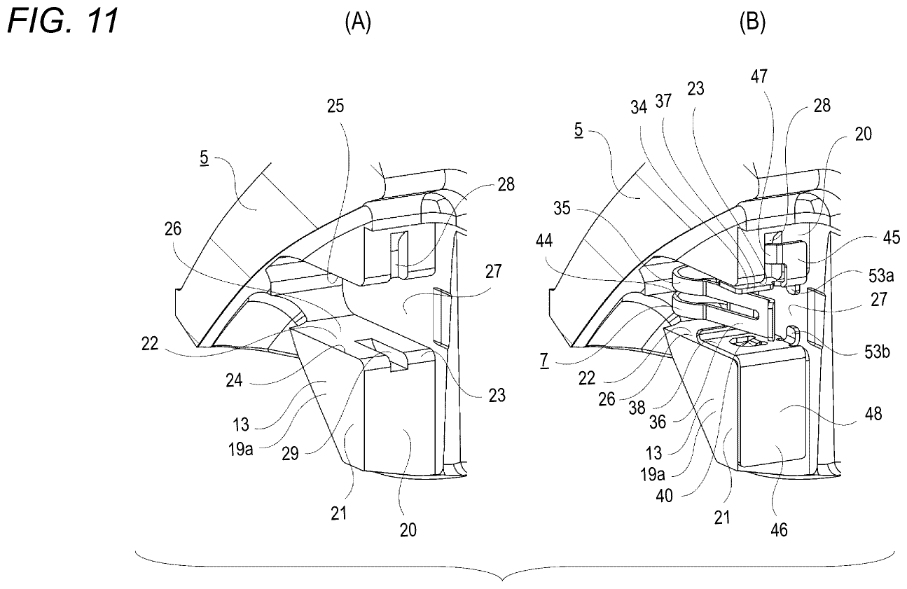

The guide wall portions 19a and 19b are provided with an outer radial groove 28 (refer to (A) of FIG. 11) extending in the radial direction at a radial outer side part of the circumferential opening portion 23 of the guide concave groove 22 on the circumferential side surface 20.

The outer radial groove 28 extends linearly in the radial direction, and the axial position thereof does not change regardless of the radial position. The groove width in the axial direction of the outer radial groove 28 is substantially constant in the radial direction, and is approximately ⅛ or more and ⅓ or less of the axial width of the circumferential side surface 20. Furthermore, the groove depth in the circumferential direction of the outer radial groove 28 is substantially constant in the radial direction. The outer radial grooves 28 open on the radial inner side and the circumferential inner side, respectively. The groove depth in the circumferential direction of the outer radial groove can be made different depending on the radial position. In addition, the outer radial groove can also be open only on the circumferential inner side.

The inner circumferential wall surface 26 of the guide concave groove 22 is provided with an inner circumferential groove 29 (refer to (A) of FIG. 11) that extends in the circumferential direction.

The inner circumferential groove 29 extends linearly in the circumferential direction, and the axial position thereof does not change regardless of the circumferential position. The groove width in the axial direction of the inner circumferential groove 29 is substantially constant in the circumferential direction, and is approximately ⅛ or more and ⅓ or less of the axial width of the inner circumferential wall surface 26. Further, the groove width in the axial direction of the inner circumferential groove 29 is substantially the same as the groove width in the axial direction of the outer radial groove 28. Further, the groove depth in the radial direction of the inner circumferential groove 29 is substantially constant in the circumferential direction. The inner circumferential grooves 29 open on the radial outer side and the circumferential inner side, respectively. The groove depth in the radial direction of the inner circumferential groove can be made different depending on the circumferential position. In addition, the inner circumferential groove can be open only on the radial outer side.

In this example, the radial inner side part of the circumferential opening portion 23 of the guide concave groove 22 on the circumferential side surface 20 of the guide wall portions 19a and 19b functions as a torque receiving surface that receives the torque acting on the inner pad 6a and the outer pad 6b during braking.

### Inner Pad and Outer Pad

The inner pad 6a is disposed between the rotor 4 and the inner body 13 in the axial direction. The outer pad 6b is disposed between the rotor 4 and the outer body 14 in the axial direction. Each of the inner pad 6a and the outer pad 6b includes a lining 30 and a metal pressure plate 31 that supports the back surface of the lining 30.

The pressure plate 31 includes lug portions 32 at the radial intermediate portions of the end portions on both circumferential sides, each of which protrudes toward the circumferential outer side of the lining 30.

The lug portion 32 is configured in a substantially rectangular plate shape. The radial width of the lug portion 32 is slightly smaller than the groove width in the radial direction of the guide concave groove 22. Further, the axial thickness (plate thickness) of the lug portion 32 is smaller than the groove depth in the axial direction of the guide concave groove 22.

The inner pad 6a has a pair of lug portions 32 provided at the end portions on both circumferentially outer sides, which are engaged with a pair of guide concave grooves 22 provided in the inner body 13 to be movable in the axial direction. Similarly, the outer pad 6b has a pair of lug portions 32 provided at the end portions on both circumferentially outer sides, which are engaged with a pair of guide concave grooves 22 provided in the outer body 14 to be movable in the axial direction. As a result, the inner pad 6a and the outer pad 6b are supported with respect to the caliper 5 to be displaceable in the axial direction but not to be displaceable in the circumferential direction and radial direction.

The pressure plate 31 has torque transmission portions 33 at the radial inner side portions of the end portions on both circumferential outer sides, each of which protrudes toward the circumferential outer sides of the lining 30. The end surface on the circumferential outer side of the torque transmission portion 33 is flat and is positioned on the circumferential inner side of the end surface on the circumferential outer side of the lug portion 32.

A shim plate 54 is attached to the back side of the pressure plate 31 to cover the back surface of the pressure plate 31.

### Pad Clip

As described above, the disc brake device 1 of this example uses four pad clips 7, and the two pad clips 7 disposed on the axial inner side of the rotor 4 have symmetrical shapes in the circumferential direction, while the two pad clips 7 disposed on the axial outer sides of the rotor 4 have symmetrical shapes in the circumferential direction. In addition, the two pad clips 7 disposed on the rotation-in side have symmetrical shapes in the axial direction, and the two pad clips 7 disposed on the rotation-out side have symmetrical shapes in the axial direction. In this manner, the shapes of the four pad clips 7 are symmetrical to each other in at least one of the axial direction and circumferential direction, and thus the detailed description of the pad clips 7 will be given only for the pad clips 7 disposed on the axial inner side and the rotation-out side, and the description of the remaining pad clips 7 will be omitted.

The pad clip 7 includes a base portion 34, a resilient portion 35, and a pressing portion 36. The pad clip 7 is made by pressing a metal plate having elasticity and corrosion resistance, such as a stainless steel plate, and has a constant overall plate thickness.

The base portion 34 has a substantially rectangular C-shape when viewed in the axial direction, and is provided on the circumferential inner half portion of the radial intermediate portion of the pad clip 7. The base portion 34 is fitted into the guide concave groove 22 to surround the lug portion 32 of the inner pad 6a. The base portion 34 holds the lug portions 32 of the inner pad 6a and ensures smooth movement in the axial direction of the inner pad 6a with respect to the caliper 5.

The base portion 34 includes: an outer circumferential side plate portion 37 disposed along the outer circumferential wall surface 25 of the guide concave groove 22; an inner circumferential side plate portion 38 disposed along the inner circumferential wall surface 26 of the guide concave groove 22; and a connecting plate portion 39 connecting the end portions on the circumferential outer sides to each other in each of the outer circumferential side plate portion 37 and the inner circumferential side plate portion 38.

The base portion 34 is fitted into the inner side of the guide concave groove 22 without rattle by elastically pressing the outer circumferential side plate portion 37 against the outer circumferential wall surface 25 and by elastically pressing the inner circumferential side plate portion 38 against the inner circumferential wall surface 26.

The outer circumferential side plate portion 37 has a flat plate shape and has an axial width that is substantially the same as that of the outer circumferential wall surface 25.

The inner circumferential side plate portion 38 has a flat plate shape and has an axial width that is substantially the same as that of the inner circumferential wall surface 26. The circumferential length of the inner circumferential side plate portion 38 is the same as the circumferential length of the outer circumferential side plate portion 37. The inner circumferential side plate portion 38 is disposed substantially parallel to the outer circumferential side plate portion 37.

In this example, the inner circumferential side plate portion 38 has a tongue-shaped claw portion 40. The claw portion 40 is formed by forming a substantially rectangular C-shaped slit at the circumferential intermediate portion of the inner circumferential side plate portion 38 and bending the inner side part of the slit on the radial inner side. The claw portion 40 extends in the direction toward the radial inner side as moving toward the axial outer side. In a state where the base portion 34 is fitted into the inner side of the guide concave groove 22, the claw portion 40 is engaged in the axial direction with the inner circumferential groove 29 provided on the inner circumferential wall surface 26. Accordingly, the inner circumferential side plate portion 38 is prevented from being displaced relative to the axial outer side with respect to the inner circumferential wall surface 26.

The connecting plate portion 39 has a flat plate shape. The end portion on the radial outer side of the connecting plate portion 39 is connected at approximately right angles to the end portion on the circumferential outer side of the outer circumferential side plate portion 37, and the end portion on the radial inner side of the connecting plate portion 39 is connected at approximately right angles to the end portion on the circumferential outer side of the inner circumferential side plate portion 38.

The connecting plate portion 39 includes: a rotor side notch 41 corresponding to the notch described in the claims at the end portion on the axial outer side, which is positioned on the side closer to the rotor 4 in the axial direction; and an opposite-rotor side notch 42 at the end portion on the axial inner side, which is positioned on the side farther from the rotor 4 in the axial direction. The rotor side notch 41 and the opposite-rotor side notch 42 are formed in a range extending from the end portion on the radial inner side to the end portion on the radial outer side in the connecting plate portion 39. The radial length of the rotor side notch 41 is greater than the radial width of the pressing portion 36.

By forming the rotor side notch 41 and the opposite-rotor side notch 42 in the connecting plate portion 39, the axial width of the connecting plate portion 39 is smaller than the axial width of each of the outer circumferential side plate portion 37 and the inner circumferential side plate portion 38, and is approximately ⅓ or more and ⅔ or less of the axial width of each of the outer circumferential side plate portion 37 and the inner circumferential side plate portion 38. In the illustrated example, the axial width of the rotor side notch 41 is larger than the axial width of the opposite-rotor side notch 42, but the notches may be the same size.

The resilient portion 35 is elastically deformed by the inner pad 6a during braking by the service brake and the parking brake, and stores resilient energy that is utilized to separate the inner pad 6a from the rotor 4.

The resilient portion 35 is provided in the circumferential outer half portion of the radial intermediate portion of the pad clip 7, and is disposed on the circumferential outer side of the base portion 34 in the guide concave groove 22 in a state where the pad clip 7 is mounted. That is, in this example, in the pad clip 7, not only the base portion 34 that holds the lug portions 32 but also the resilient portion 35 that stores resilient energy is accommodated in the guide concave groove 22.

In this example, the resilient portion 35 has a substantially C-shape when viewed in the radial direction, and is configured in a partial cylindrical shape (substantially semi-cylindrical shape). The resilient portion 35 is configured with a circumferential extension portion 35a extending from the end portion on the axial inner side toward the circumferential outer side in the connecting plate portion 39 that forms the base portion 34, and a curved portion 35b that is curved in an arc shape in the direction from the end portion on the circumferential outer side of the circumferential extension portion 35a toward the axial outer side as moving toward the circumferential outer side, and that is then curved in an arc shape in the direction toward the circumferential inner side as moving toward the axial outer side. However, the shape of the resilient portion is not limited to the above-mentioned shape, and it may be configured in a substantially J-shape, a substantially V-shape, a substantially M-shape, or the like when viewed in the radial direction.

The end portion on the circumferential inner side of the circumferential extension portion 35a that forms the end portion on one side of the resilient portion 35 is connected to the end portion on the axial inner side of the connecting plate portion 39. The end portions on the circumferential inner side of the circumferential extension portion 35a are positioned on the axial outer sides of the end portions on the axial inner sides of each of the outer circumferential side plate portion 37 and the inner circumferential side plate portion 38 that form the base portion 34. Therefore, in a state where the end portions on the axial inner sides of each of the outer circumferential side plate portion 37 and the inner circumferential side plate portion 38 that form the base portion 34 are abutted against the axial bottom surface 27 of the guide concave groove 22, a gap is formed between the axial inner side surface of the circumferential extension portion 35a and the axial bottom surface 27. In this example, tongue-shaped abutment pieces 53a and 53b provided at the circumferential intermediate portions of the end portions on the axial inner sides of each of the outer circumferential side plate portion 37 and the inner circumferential side plate portion 38 abut against the axial bottom surface 27 of the guide concave groove 22, but the abutment pieces can be omitted.

The end portion on the circumferential inner side of the curved portion 35b that forms the end portion on the other side of the resilient portion 35 is connected to the end portion on the circumferential outer side of the pressing portion 36. The end portion on the circumferential inner side of the curved portion 35b is disposed on the axial outer side of the end portion on the axial outer side of the connecting plate portion 39.

The pressing portion 36 extends toward the circumferential inner side from the end portion on the other side of the resilient portion 35. In this example, when the pad clip 7 (resilient portion 35) is in a free state, the pressing portion 36 is slightly inclined in a direction toward the axial inner side as moving toward the circumferential inner side. Therefore, when the pad clip 7 is in a free state, the pressing portion 36 approaches the axial bottom surface 27 of the guide concave groove 22 as moving toward the circumferential inner side.

In this example, the circumferential outer side portion of the pressing portion 36 is disposed on the inner side of the rotor side notch 41 provided in the connecting plate portion 39. In other words, the pressing portion 36 extends in the circumferential direction through the rotor side notch 41. Therefore, most of the pressing portion 36 is disposed at the part between the outer circumferential side plate portion 37 and the inner circumferential side plate portion 38 in the radial direction. The pressing portion 36 presses the inner pad 6a toward the axial inner side, that is, in the direction away from the rotor 4 in the axial direction by the elastic force of the resilient portion 35.

In this example, the axial inner side surface of the circumferential inner side portion of the pressing portion 36 presses the axial outer side surface of the lug portion 32 of the inner pad 6a toward the axial inner side.

The pressing portion 36 has a substantially L-shape (including a J-shape) when viewed in the radial direction, and includes a bent portion 43 on the axial inner side portion. In this example, the convex surface formed by the axial inner side surface of the bent portion 43 is brought into contact with the axial outer side surface of the lug portion 32 of the inner pad 6a, thereby pressing the lug portion 32 to the axial inner side.

A cutout portion 44 is formed in a range extending from a part near one of the resilient portion 35 to the circumferential inner side portion of the pressing portion 36. The cutout portion 44 has a function of relieving the stress acting on the resilient portion 35 and the pressing portion 36. In this example, the cutout portion 44 is configured by a slit (through-hole) formed at the intermediate portion in the resilient portion 35 and the pressing portion 36 in the width direction.

Neither the resilient portion 35 nor the pressing portion 36 protrudes to the axial outer side from the axial opening portion 24 of the guide concave groove 22. In other words, the shape of the resilient portion 35 changes when braking is applied and when not braking, and the axial position of the pressing portion 36 changes when braking is applied and when not braking, but the resilient portion 35 and the pressing portion 36 do not protrude to the axial outer side from the axial opening portion 24 of the guide concave groove 22 in either the braking or non-braking state.

The pad clip 7 of this example further includes an outwardly bent plate portion 45 and an inwardly bent plate portion 46.

The outwardly bent plate portion 45 bends at approximately a right angle from the end portion on the circumferential inner side of the outer circumferential side plate portion 37 that forms the base portion 34 toward the radial outer side, and covers the radial outer side part of the circumferential opening portion 23 on the circumferential side surface 20 of the guide wall portion 19a. The axial width of the outwardly bent plate portion 45 is smaller than the axial width of the outer circumferential side plate portion 37, and is approximately ¼ or more and ⅔ or less of the axial width of the outer circumferential side plate portion 37. In this example, the outwardly bent plate portion 45 is connected to the end portion on the axial inner side of the end portion on the circumferential inner side of the outer circumferential side plate portion 37.

The inwardly bent plate portion 46 bends at approximately a right angle from the end portion on the circumferential inner side of the inner circumferential side plate portion 38 that forms the base portion 34 toward the radial inner side, and covers the radial inner side part of the circumferential opening portion 23 on the circumferential side surface 20 of the guide wall portion 19a. The axial width of the inwardly bent plate portion 46 is the same as the axial width of the inner circumferential side plate portion 38.

In this example, the outwardly bent plate portion 45 and the inwardly bent plate portion 46 are disposed substantially parallel to each other and at the same circumferential position. That is, the circumferential outer side surface of the outwardly bent plate portion 45 and the circumferential outer surface of the inwardly bent plate portion 46 are positioned on the same imaginary plane.

In this example, the outwardly bent plate portion 45 has a tongue-shaped claw portion 47. The claw portion 47 extends toward the axial outer side from the end portion on the radial outer side of the outwardly bent plate portion 45. The claw portion 47 extends in the direction toward the circumferential outer side as moving toward the axial outer side. The claw portion 47 is engaged in the axial direction with the outer radial groove 28 provided on the circumferential side surface 20 in a state where the base portion 34 is fitted into the inner side of the guide concave groove 22 and the outwardly bent plate portion 45 covers the circumferential side surface 20 of the guide wall portion 19a. Accordingly, the outwardly bent plate portion 45 is prevented from being displaced to the axial outer side with respect to the circumferential side surface 20.

In this example, the inwardly bent plate portion 46 has a pressure receiving portion 48 that receives the torque acting on the inner pad 6a during braking. The pressure receiving portion 48 covers a torque receiving surface provided on the circumferential side surface 20 of the guide wall portion 19a, and is abutted against the circumferential end surface of the torque transmission portion 33 of the inner pad 6a during braking.

In the pad clip 7 of this example having the above-mentioned configuration, the bent portion 43 provided on the pressing portion 36 is always in contact with the axial outer side surface of the lug portion 32 of the inner pad 6a or the axial inner side surface of the lug portion 32 of the outer pad 6b.

In the pad clip 7 of this example, when the pistons 8 and 9 press the inner pad 6a and the outer pad 6b in the direction of approaching the rotor 4 in the axial direction during braking by the service brake and the parking brake, the pressing portion 36 which is in contact with the lug portion 32 is displaced in the axial direction to be closer to the rotor 4, and elastic deformation occurs in the resilient portion 35. Specifically, the resilient portion 35 is elastically deformed such that the distance in the axial direction between the end portion on one side and the end portion on the other side is increased. This causes the resilient portion 35 to store elastic energy.

In the pad clip 7 of this example, when braking is released, the elastic restoring force of the piston seal (not illustrated) pulls the pistons 8 and 9 back to the deep side of the cylinder 12, and the elastic restoring force of the resilient portion 35 presses the inner pad 6a or the outer pad 6b in the direction away from the rotor 4 in the axial direction via the pressing portion 36. As a result, the inner pad 6a and the outer pad 6b are moved to a position where dragging with the rotor 4 can be prevented.

According to the opposed piston-type disc brake device 1 of this example as described above, the pad clip 7 can be disposed without interfering with other members, and the pad clip 7 can apply sufficient pressing force in the axial direction to each of the inner pad 6a and the outer pad 6b to separate the inner pad 6a and the outer pad 6b from the rotor 4.

That is, according to the disc brake device 1 of this example, the elastic force of the resilient portion 35 that forms the pad clip 7 can press the inner pad 6a or the outer pad 6b only in the direction away from the rotor 4 in the axial direction via the pressing portion 36. Therefore, compared to the conventional structure described above in which component forces are utilized to apply pressure in the axial direction, a larger pressing force can be applied to the inner pad 6a or the outer pad 6b in the axial direction.

In particular, in the disc brake device 1 of this example, when the braking force of the parking brake is released, the two pad clips 7 disposed on the axial outer side need to move the clamp member 10 to the axial outer side with respect to the caliper 5 when moving the outer pad 6b to the axial outer side. For this reason, a large force is required to move the outer pad 6b to the axial outer side. However, according to the pad clip 7 of this example, a large pressing force in the axial direction can be applied to the outer pad 6b, making it possible to sufficiently separate the outer pad 6b from the rotor 4, thereby effectively preventing dragging between the outer pad 6b and the rotor 4.

In addition, in a state where the pad clip 7 is mounted, not only the base portion 34 that holds the lug portion 32 but also the resilient portion 35 are disposed on the inner side of the guide concave groove 22. Furthermore, by extending the pressing portion 36 toward the circumferential inner side from the resilient portion 35, the pressing portion 36 is also disposed on the inner side of the guide concave groove 22. As described above, both the resilient portion 35 and the pressing portion 36 are accommodated in the guide concave groove 22 for engaging the lug portion 32, and thus, despite a configuration in which the inner body 13 is disposed close to the back surface side (axial inner side) of the inner pad 6a, and the outer body 14 is disposed close to the back surface side (axial outer side) of the outer pad 6b, the pad clip 7 can be disposed without interfering with other members.

In addition, in this example, the shapes and dimensions of each of the resilient portion 35 and the pressing portion 36 are regulated such that neither the resilient portion 35 nor the pressing portion 36 protrudes to the axial outer side from the axial opening portion 24 of the guide concave groove 22, thereby preventing the pad clip 7 from interfering with the rotor 4.

In addition, since the resilient portion 35 is disposed on the circumferential outer side of the base portion 34 in the guide concave groove 22, the distance in the circumferential direction from the resilient portion 35 to the lug portion 32 can be increased. Therefore, the stress caused by the elastic deformation of the resilient portion 35 during braking can be suppressed. Accordingly, the pad clip 7 can avoid plastic deformation from the brand-new state to a worn condition of the lining 30, such that a pressing force can be stably applied to the inner pad 6a or the outer pad 6b.

Furthermore, in this example, since a part of the resilient portion 35 and the pressing portion 36 is provided with the cutout portion 44 configured by a slit, the stress generated in the resilient portion 35 and the pressing portion 36 can be suppressed more effectively.

In addition, in this example, the claw portion 47 provided on the outwardly bent plate portion 45 is engaged in the axial direction with the outer radial groove 28 provided on the circumferential side surface 20 of the guide wall portions 19a and 19b, and the claw portion 40 provided on the inner circumferential side plate portion 38 is engaged in the axial direction with the inner circumferential groove 29 provided on the inner circumferential wall surface 26 of the guide concave groove 22. Therefore, the pad clip 7 can be prevented from tilting (rotating) due to a reaction force generated when the pressing portion 36 presses the inner pad 6a or the outer pad 6b. Therefore, the posture of the pad clip 7 can be stabilized, and a pressing force can be stably applied to the inner pad 6a or the outer pad 6b.

Furthermore, in this example, when braking is released, the bent portion 43 of the pressing portion 36 of the pad clip 7 can press the axial side surface of the lug portion 32, and thus the abutment position between the lug portion 32 and the pressing portion 36 can be kept constant. Therefore, it is possible to suppress variation in the direction and magnitude of the pressing force applied to the inner pad 6a and the outer pad 6b.

In this example, since the guide concave groove 22 accommodates not only the base portion 34 that holds the lug portion 32 but also the resilient portion 35, the circumferential dimension of the guide concave groove 22 becomes longer compared to when a pad clip without the resilient portion 35 is used. As a result, the thickness of the end portions on the circumferential outer sides of the inner body 13 and the outer body 14 is reduced. However, since the thickness of the end portions on the circumferential outer side of each of the inner body 13 and the outer body 14 has a sufficiently small effect on the rigidity and strength of the caliper 5, even when the circumferential dimension of the guide concave groove 22 is lengthened to accommodate the resilient portion 35, the strength and rigidity of the caliper 5 can be sufficiently ensured.

### Second Example of Embodiment

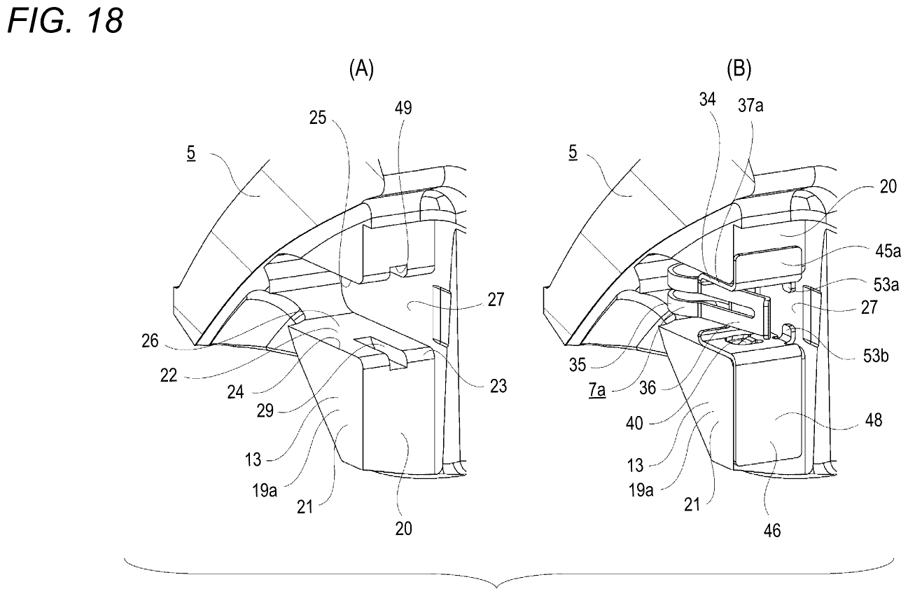

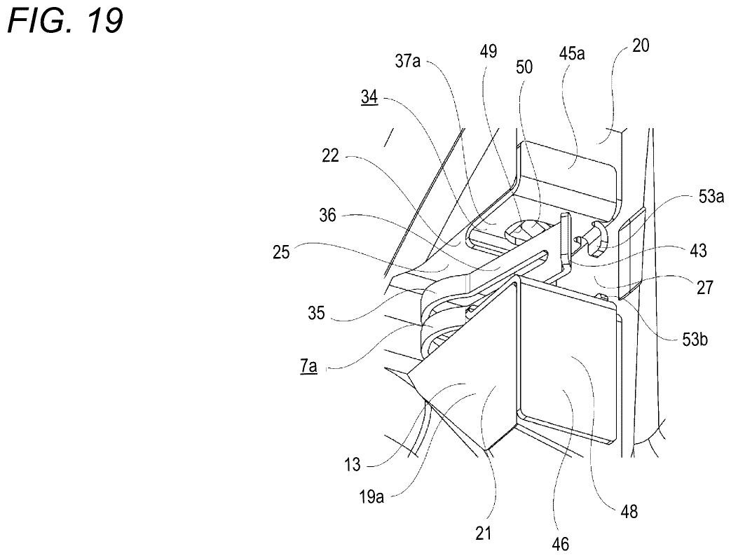

A second example of the embodiment will be described with reference to FIGS. 18 and 19. In this example, components similar to those in the first example of the embodiment will be given the same reference signs as those in the first example of the embodiment, and the detailed descriptions thereof will be omitted.

In this example, only the structure of a pad clip 7a and the structure of the guide wall portion 19a (19b) are different from the structure of the first example of the embodiment.

In this example, instead of not providing the outer radial groove 28 (refer to (A) of FIG. 11) extending in the radial direction on the circumferential side surface 20 of the guide wall portion 19a (19b), an outer circumferential groove 49 extending in the circumferential direction is provided on the outer circumferential wall surface 25 of the guide concave groove 22.

The outer circumferential groove 49 extends linearly in the circumferential direction, and the axial position thereof does not change regardless of the circumferential position. The groove width in the axial direction of the outer circumferential groove 49 is substantially constant in the circumferential direction, and is approximately ⅛ or more and ⅓ or less of the axial width of the outer circumferential wall surface 25. Additionally, the groove width in the axial direction and the axial position of the outer circumferential groove 49 are substantially the same as the groove width in the axial direction and the axial position of the inner circumferential groove 29. Further, the groove depth in the radial direction of the outer circumferential groove 49 is substantially constant in the circumferential direction. The outer circumferential grooves 49 open on the radial inner side and the circumferential inner side, respectively. The groove depth in the radial direction of the outer circumferential groove can be made different depending on the circumferential position. In addition, the outer circumferential groove can be open only on the radial inner side.

An outwardly bent plate portion 45a of the pad clip 7a of this example does not include the claw portion 47 (refer to (B) of FIG. 11), and is entirely formed in a flat plate shape. The axial width of the outwardly bent plate portion 45a is the same as the axial width of the outer circumferential side plate portion 37a.

The pad clip 7a of this example has a tongue-shaped claw portion 50 on the outer circumferential side plate portion 37a. The claw portion 50 is formed by forming a substantially rectangular C-shaped slit at the circumferential intermediate portion of the outer circumferential side plate portion 37a and bending the inner side part of the slit on the radial outer side. The claw portions 50 extend in the direction toward the radial outer side as moving toward the axial outer side. In a state where the base portion 34 is fitted into the inner side of the guide concave groove 22, the claw portion 50 is engaged in the axial direction with the outer circumferential groove 49 provided on the outer circumferential wall surface 25. Accordingly, the outer circumferential side plate portion 37a is prevented from being displaced relative to the axial outer side with respect to the outer circumferential wall surface 25.

In this example described above, the claw portion 50 provided on the outer circumferential side plate portion 37a is engaged in the axial direction with the outer circumferential groove 49 provided on the outer circumferential wall surface 25 of the guide concave groove 22, and the claw portion 40 provided on the inner circumferential side plate portion 38 is engaged in the axial direction with the inner circumferential groove 29 provided on the inner circumferential wall surface 26 of the guide concave groove 22. Therefore, the pad clip 7a can be prevented from tilting due to a reaction force generated when the pressing portion 36 presses the inner pad 6a or the outer pad 6b. Therefore, the posture of the pad clip 7a can be stabilized, and a pressing force can be stably applied to the inner pad 6a or the outer pad 6b.

In addition, the outer circumferential groove 49 and the inner circumferential groove 29 can also be simultaneously machined by cutting, which is advantageous in terms of reducing machining costs.

The other configurations and effects are the same as those of the first example of the embodiment.

### Third Example of Embodiment

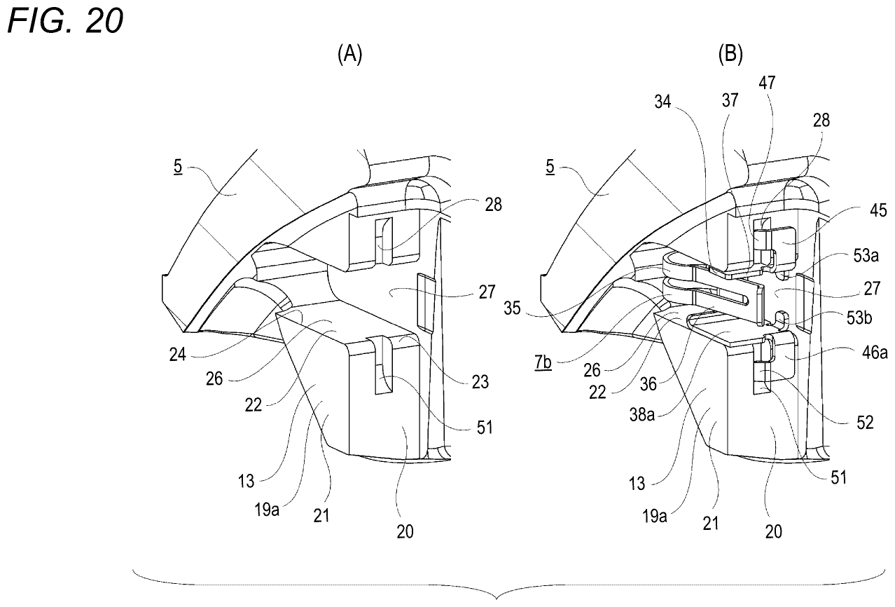

A third example of the embodiment will be described with reference to FIG. 20. In this example, components similar to those in the first example of the embodiment will be given the same reference signs as those in the first example of the embodiment, and the detailed descriptions thereof will be omitted.

In this example, only the structure of a pad clip 7b and the structure of the guide wall portion 19a (19b) are different from the structure of the first example of the embodiment.

In this example, instead of not providing an inner circumferential groove 29 (refer to (A) of FIG. 11) on the inner circumferential wall surface 26 of the guide concave groove 22 of the guide wall portion 19a (19b), an inner radial groove 51 extending in the radial direction is provided at the radial inner side part of the circumferential opening portion 23 of the guide concave groove 22 on the circumferential side surface 20.

The inner radial groove 51 extends linearly in the radial direction, and the axial position thereof does not change regardless of the radial position. The groove width in the axial direction of the inner radial groove 51 is substantially constant in the radial direction, and is approximately ⅛ or more and ⅓ or less of the axial width of the circumferential side surface 20. Additionally, the groove width in the axial direction and the axial position of the inner radial groove 51 are substantially the same as the groove width in the axial direction and the axial position of the outer radial groove 28. Furthermore, the groove depth in the circumferential direction of the inner radial groove 51 is substantially constant in the radial direction. The inner radial grooves 51 open on the radial outer side and the circumferential inner side, respectively. The groove depth in the circumferential direction of the inner radial groove can be made different depending on the radial position. In addition, the inner radial groove can also be open only on the circumferential inner side.

An inner circumferential side plate portion 38a of the pad clip 7b of this example does not include the claw portion 40 (refer to (B) of FIG. 11), and is configured as a flat plate as a whole.

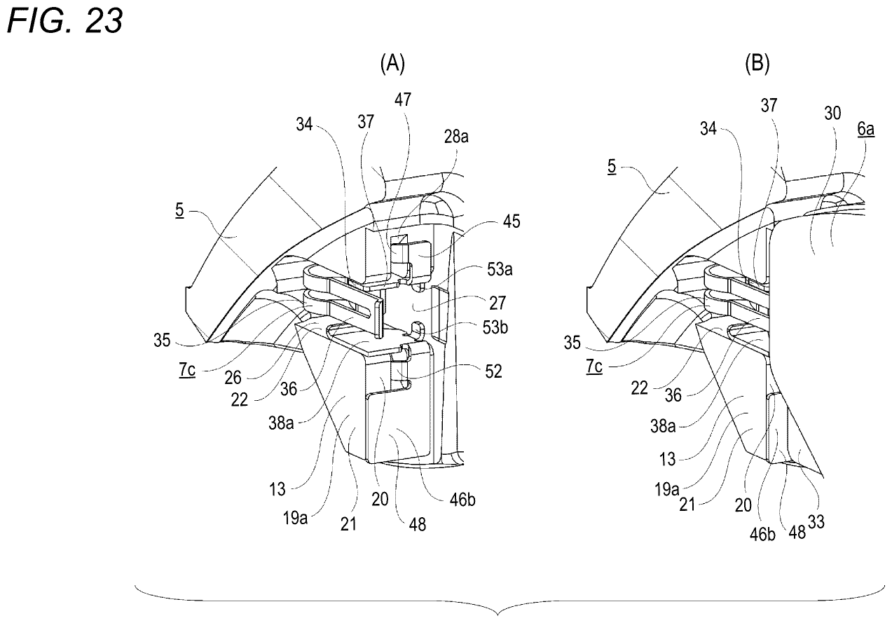

The pad clip 7b of this example has a tongue-shaped claw portion 52 on an inwardly bent plate portion 46a. The claw portion 52 extends toward the axial outer side from the end portion on the radial inner side of the inwardly bent plate portion 46a. The claw portion 52 extends in the direction toward the circumferential outer side as moving toward the axial outer side. The claw portion 52 is engaged in the axial direction with the inner radial groove 51 provided on the circumferential side surface 20 in a state where the base portion 34 is fitted into the inner side of the guide concave groove 22 and the inwardly bent plate portion 46a covers the circumferential side surface 20 of the guide wall portion 19a. Accordingly, the inwardly bent plate portion 46a is prevented from being displaced to the axial outer side with respect to the circumferential side surface 20. The inwardly bent plate portion 46a has the claw portion 52, but does not have the flat pressure receiving portion 48 (refer to (A) of FIG. 23).

In this example described above, the claw portion 47 provided on the outwardly bent plate portion 45 is engaged in the axial direction with the outer radial groove 28 provided on the circumferential side surface 20 of the guide wall portions 19a and 19b, and the claw portion 52 provided on the inwardly bent plate portion 46a is engaged in the axial direction with the inner radial groove 51 provided on the circumferential side surface 20. As a result, the pad clip 7b can be prevented from tilting due to the reaction force generated when the pressing portion 36 presses the inner pad 6a or the outer pad 6b. Therefore, the posture of the pad clip 7b can be stabilized, and a pressing force can be stably applied to the inner pad 6a or the outer pad 6b.

In addition, the outer radial groove 28 and the inner radial groove 51 can be machined by linearly moving a cutting tool in the radial direction, which is advantageous in reducing the number of machining steps.

The other configurations and effects are the same as those of the first example of the embodiment.

### Fourth Example of Embodiment

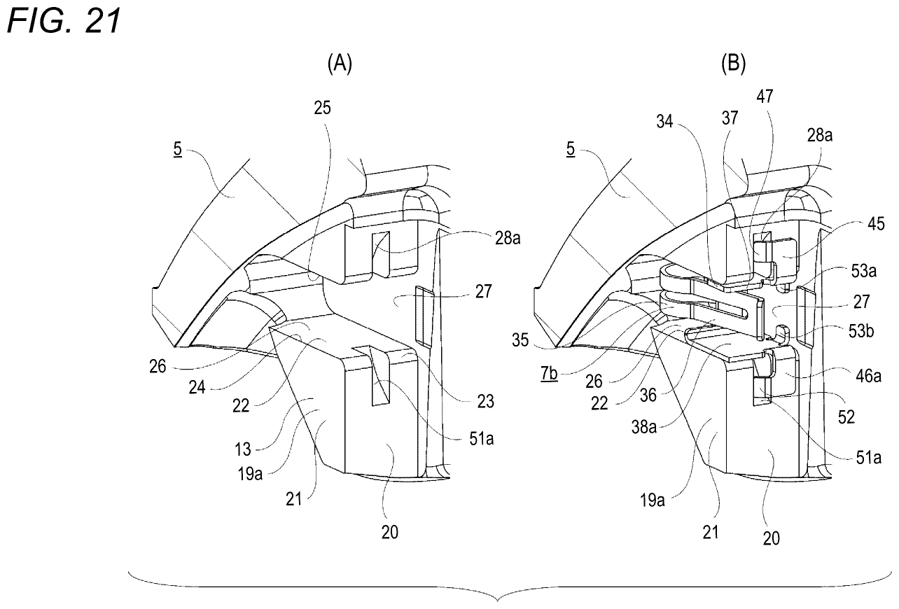

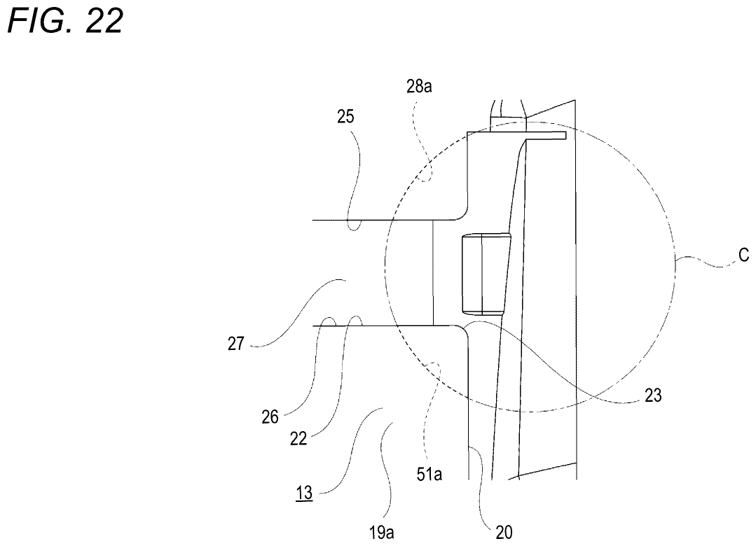

A fourth example of the embodiment will be described with reference to FIGS. 21 and 22. In this example, components similar to those in the first example of the embodiment will be given the same reference signs as those in the first example of the embodiment, and the detailed descriptions thereof will be omitted.

This example is a modification example of the third example of the embodiment. In this example, the groove bottom surfaces of an outer radial groove 28a and an inner radial groove 51a provided on the circumferential side surface 20 of the guide wall portion 19a (19b) are each configured as partial cylindrical surfaces. Furthermore, the groove bottom surfaces of the outer radial groove 28a and the inner radial groove 51a are disposed on the same imaginary cylindrical surface C.

In this example as described above, the outer radial groove 28a and the inner radial groove 51a can be machined simultaneously by cutting such as milling, and thus the number of machining steps and the machining costs can be reduced.

The other configurations and effects are the same as those of the first example and the third example of the embodiment.

### Fifth Example of Embodiment

A fifth example of the embodiment will be described with reference to FIG. 23. In this example, components similar to those in the first example of the embodiment will be given the same reference signs as those in the first example of the embodiment, and the detailed descriptions thereof will be omitted.

This example is a modification example of the third example of the embodiment. A pad clip 7c of this example is provided with the pressure receiving portion 48 as well as a tongue-shaped claw portion 52 on an inwardly bent plate portion 46b.

The claw portion 52 is provided on the radial outer side portion of the inwardly bent plate portion 46b, and extends in the direction toward the circumferential outer side as moving toward the axial outer side. The pressure receiving portion 48 is provided on the radial inner side portion of the inwardly bent plate portion 46b.

In this example as described above, the inwardly bent plate portion 46b of the pad clip 7c is provided with the pressure receiving portion 48, and thus the pressure receiving portion 48 can protect the circumferential side surface 20 of the guide wall portion 19a.

The other configurations and effects are the same as those of the first example and the third example of the embodiment.

Although the embodiment of the present invention has been described above, the present invention is not limited to this, and can be modified as appropriate without departing from the technical concept of the invention. Furthermore, the structures of each example of the embodiment can be combined as appropriate as long as no contradiction occurs.

When implementing the present invention, the shapes of the resilient portion, the claw portion, and the like that form the pad clip are not limited to the structures of the examples of the embodiment, and can be modified as appropriate. Furthermore, the overall length, depth, and formation positions of the outer radial groove, inner radial groove, outer circumferential groove, and inner circumferential groove are not limited to the structures of each example of the embodiments, and can be changed as appropriate.

Here, the features of the embodiment of the caliper for the opposed piston-type disc brake according to the present invention described above will be briefly summarized and listed below.

[1]

An opposed piston-type disc brake device (1) including:
a caliper (5) having two or more cylinders (12) and configured to be fixed to a suspension device;
a pad (6a, 6b) supported to be movable in an axial direction with respect to the caliper (5); and
a pad clip (7) made of a metal plate and disposed between the caliper (5) and the pad (6a, 6b), in which
the caliper (5) includes a guide wall portion (19a, 19b) at a part adjacent to a circumferential outer side of the pad (6a, 6b), the guide wall portion having a circumferential side surface (20) facing the pad (6a, 6b) in a circumferential direction and an axial side surface (21) facing a rotor (4) in the axial direction, respectively,
the guide wall portion (19a, 19b) includes a guide concave groove (22) extending in the circumferential direction and having a circumferential opening portion (23) opening on the circumferential side surface (20) and an axial opening portion (24) opening on the axial side surface (21), respectively,
the pad (6a, 6b) includes a lug portion (32) that is configured to be engaged in the axial direction with the guide concave groove (22) to be movable, and
the pad clip (7) has a substantially rectangular C-shape when viewed in the axial direction, and includes a base portion (34) that is fitted into the guide concave groove (22) to surround the lug portion (32), a resilient portion (35) that has an end portion on one side connected to the base portion (34) and that is disposed on the circumferential outer side of the base portion (34) in the guide concave groove (22), and a pressing portion (36) that extends toward a circumferential inner side from an end portion on the other side of the resilient portion (35) and that is configured to press the pad (6a, 6b) in a direction away from the rotor (4) in the axial direction by an elastic force of the resilient portion (35).
   [2]

The opposed piston-type disc brake device (1) according to the above [1], in which
the resilient portion (35) is configured in a partial cylindrical shape that is substantially C-shaped when viewed in a radial direction.
   [3]

The opposed piston-type disc brake device (1) according to the above [1], in which
the base portion (34) has an outer circumferential side plate portion (37) disposed along an outer circumferential wall surface (25) facing a radial inner side in the guide concave groove (22), an inner circumferential side plate portion (38) disposed along an inner circumferential wall surface (26) facing a radial outer side in the guide concave groove (22), and a connecting plate portion (39) connecting end portions on the circumferential outer sides of each of the outer circumferential side plate portion (37) and the inner circumferential side plate portion (38), and
the end portion on one side of the resilient portion (35) is connected to an end portion on a side farther from the rotor (4) in the axial direction in the connecting plate portion (39).
   [4]

The opposed piston-type disc brake device (1) according to the above [3], in which
the pad clip (7) further includes an outwardly bent plate portion (45) bent toward the radial outer side from the end portion on the circumferential inner side of the outer circumferential side plate portion (37), and an inwardly bent plate portion (46) bent toward the radial inner side from the end portion on the circumferential inner side of the inner circumferential side plate portion.
   [5]

The opposed piston-type disc brake device (1) according to the above [4], in which
an outer circumferential groove (49) extending in the circumferential direction is provided on the outer circumferential wall surface (25) of the guide concave groove (22), and a claw portion (50) that is configured to be engaged with the outer circumferential groove (49) is provided on the outer circumferential side plate portion (37), or
an outer radial groove (28) extending in the radial direction is provided at a radial outer side part of the circumferential opening portion (23) of the guide concave groove (22) on the circumferential side surface (20) of the guide wall portion (19a, 19b), and a claw portion (47) that is configured to be engaged with the outer radial groove (28) is provided on the outwardly bent plate portion (45).
   [6]

The opposed piston-type disc brake device (1) according to the above [4], in which
an inner circumferential groove (29) extending in the circumferential direction is provided on the inner circumferential wall surface (26) of the guide concave groove (22), and a claw portion (40) that is configured to be engaged with the inner circumferential groove (29) is provided on the inner circumferential side plate portion (38), or
an inner radial groove (51) extending in the radial direction is provided at a radial inner side part of the circumferential opening portion (23) of the guide concave groove (22) on the circumferential side surface (20) of the guide wall portion (19a, 19b), and a claw portion (52) that is configured to be engaged with the inner radial groove (51) is provided on the inwardly bent plate portion (46).
   [7]

The opposed piston-type disc brake device (1) according to the above [4], in which
an outer radial groove (28) extending in the radial direction is provided at the radial outer side part of the circumferential opening portion (23) of the guide concave groove (22) on the circumferential side surface (20) of the guide wall portion (19a, 19b), and a claw portion (47) that is configured to be engaged with the outer radial groove (28) is provided on the outwardly bent plate portion (45), and
an inner circumferential groove (29) extending in the circumferential direction is provided on the inner circumferential wall surface (26) of the guide concave groove (22), and a claw portion (40) that is configured to be engaged with the inner circumferential groove (29) is provided on the inner circumferential side plate portion (38).
   [8]

The opposed piston-type disc brake device (1) according to the above [4], in which
an outer radial groove (28a) extending in the radial direction is provided at the radial outer side part of the circumferential opening portion (23) of the guide concave groove (22) on the circumferential side surface (20) of the guide wall portion (19a, 19b), and a claw portion (47) that is configured to be engaged with the outer radial groove (28a) is provided on the outwardly bent plate portion (45),
an inner radial groove (51a) extending in the radial direction is provided at the radial inner side part of the circumferential opening portion (23) of the guide concave groove (22) on the circumferential side surface (20) of the guide wall portion (19a, 19b), and a claw portion (52) that is configured to be engaged with the inner radial groove (51a) is provided on the inwardly bent plate portion (46), and
a groove bottom surface of the outer radial groove (28a) and a groove bottom surface of the inner radial groove (51a) are disposed on the same imaginary cylindrical surface.
   [9]

The opposed piston-type disc brake device (1) according to the above [3], in which
the connecting plate portion (39) has a notch (rotor side notch 41) at an end portion on a side closer to the rotor (4) in the axial direction, and
a part of the resilient portion (35) or a part of the pressing portion (36) is disposed on an inner side of the notch.
   [10]

The opposed piston-type disc brake device (1) according to the above [4], in which
at least one of the inwardly bent plate portion (46b) and the outwardly bent plate portion (45) has a pressure receiving portion (48) that is configured to receive a torque acting on the pad (6a, 6b) during braking.
   [11]

The opposed piston-type disc brake device (1) according to the above [1], in which
each of the resilient portion (35) and the pressing portion (36) does not protrude from the axial opening portion (24) of the guide concave groove (22) to a side of the rotor (4) in the axial direction.
   [12]

The opposed piston-type disc brake device (1) according to the above [1], in which
the resilient portion (35) includes a cutout portion (44).
   [13]

The opposed piston-type disc brake device (1) according to the above [1], in which
the pressing portion (36) is configured to press an axial side surface of the lug portion (32) of the pad (6a, 6b).

This application is based on a Japanese patent application (Patent Application No. 2022-206729) filed on Dec. 23, 2022, the contents of which are incorporated by reference into this application.

### INDUSTRIAL APPLICABILITY

According to the opposed piston-type disc brake device of the present invention, it is possible to realize the opposed piston-type disc brake device in which the pad clip can be disposed without interfering with other members, and the pad clip can apply a sufficient pressing force in the axial direction to the pad to separate the pad from the rotor.

### REFERENCE SIGNS LIST

1: disc brake device
2: opposed piston-type brake mechanism portion
3: floating-type brake mechanism portion
4: rotor
5: caliper
6a: inner pad
6b: outer pad
7, 7a, 7b, 7c: pad clip
8: service-only piston
9: dual-purpose piston
10: clamp member
11: electric actuator
12: cylinder
13: inner Body
14: outer Body
15a, 15b, 15c: connecting portion
16: claw portion
17: electric drive unit
19a, 19b: guide wall portion
20: circumferential side surface
21: axial side surface
22: guide concave groove
23: circumferential opening portion
24: axial opening portion
25: outer circumferential wall surface
26: inner circumferential wall surface
27: axial bottom surface
28, 28a: outer radial groove
29: inner circumferential groove
30: lining
31: pressure plate
32: lug portion
33: torque transmission portion
34: base portion
35: resilient portion
35a: circumferential extension portion
35b: curved portion
36: pressing portion
37, 37a: outer circumferential side plate portion
38, 38a: inner circumferential side plate portion
39: connecting plate portion
40: claw portion
41: rotor side notch
42: opposite-rotor side notch
43: bent portion
44: cutout portion
45, 45a: outwardly bent plate portion
46, 46a, 46b: inwardly bent plate portion
47: claw portion
48: pressure receiving portion
49: outer circumferential groove
50: claw portion
51, 51a: inner radial groove
52: claw portion
53a, 53b: abutment piece
54: shim plate

1. An opposed piston-type disc brake device comprising:
a caliper having two or more cylinders and configured to be fixed to a suspension device;
a pad supported to be movable in an axial direction with respect to the caliper; and
a pad clip made of a metal plate and disposed between the caliper and the pad, wherein
the caliper includes a guide wall portion at a part adjacent to a circumferential outer side of the pad, the guide wall portion having a circumferential side surface facing the pad in a circumferential direction and an axial side surface facing a rotor in the axial direction, respectively,
the guide wall portion includes a guide concave groove extending in the circumferential direction and having a circumferential opening portion opening on the circumferential side surface and an axial opening portion opening on the axial side surface, respectively,
the pad includes a lug portion that is configured to be engaged in the axial direction with the guide concave groove to be movable, and the pad clip has a substantially rectangular C-shape when viewed in the axial direction, and includes a base portion that is fitted into the guide concave groove to surround the lug portion, a resilient portion that has an end portion on one side connected to the base portion and that is disposed on the circumferential outer side of the base portion in the guide concave groove, and a pressing portion that extends toward a circumferential inner side from an end portion on the other side of the resilient portion and that is configured to press the pad in a direction away from the rotor in the axial direction by an elastic force of the resilient portion.

2. The opposed piston-type disc brake device according to claim 1, wherein
the resilient portion is configured in a partial cylindrical shape that is substantially C-shaped when viewed in a radial direction.

3. The opposed piston-type disc brake device according to claim 1, wherein
the base portion has an outer circumferential side plate portion disposed along an outer circumferential wall surface facing a radial inner side in the guide concave groove, an inner circumferential side plate portion disposed along an inner circumferential wall surface facing a radial outer side in the guide concave groove, and a connecting plate portion connecting end portions on the circumferential outer sides of each of the outer circumferential side plate portion and the inner circumferential side plate portion, and
the end portion on one side of the resilient portion is connected to an end portion on a side farther from the rotor in the axial direction in the connecting plate portion.

4. The opposed piston-type disc brake device according to claim 3, wherein
the pad clip further includes an outwardly bent plate portion bent toward the radial outer side from the end portion on the circumferential inner side of the outer circumferential side plate portion, and an inwardly bent plate portion bent toward the radial inner side from the end portion on the circumferential inner side of the inner circumferential side plate portion.

5. The opposed piston-type disc brake device according to claim 4, wherein
an outer circumferential groove extending in the circumferential direction is provided on the outer circumferential wall surface of the guide concave groove, and a claw portion that is configured to be engaged with the outer circumferential groove is provided on the outer circumferential side plate portion, or
an outer radial groove extending in the radial direction is provided at a radial outer side part of the circumferential opening portion of the guide concave groove on the circumferential side surface of the guide wall portion, and a claw portion that is configured to be engaged with the outer radial groove is provided on the outwardly bent plate portion.

6. The opposed piston-type disc brake device according to claim 4, wherein
an inner circumferential groove extending in the circumferential direction is provided on the inner circumferential wall surface of the guide concave groove, and a claw portion that is configured to be engaged with the inner circumferential groove is provided on the inner circumferential side plate portion, or
an inner radial groove extending in the radial direction is provided at a radial inner side part of the circumferential opening portion of the guide concave groove on the circumferential side surface of the guide wall portion, and a claw portion that is configured to be engaged with the inner radial groove is provided on the inwardly bent plate portion.

7. The opposed piston-type disc brake device according to claim 4, wherein
an outer radial groove extending in the radial direction is provided at the radial outer side part of the circumferential opening portion of the guide concave groove on the circumferential side surface of the guide wall portion, and a claw portion that is configured to be engaged with the outer radial groove is provided on the outwardly bent plate portion, and
an inner circumferential groove extending in the circumferential direction is provided on the inner circumferential wall surface of the guide concave groove, and a claw portion that is configured to be engaged with the inner circumferential groove is provided on the inner circumferential side plate portion.

8. The opposed piston-type disc brake device according to claim 4, wherein
an outer radial groove extending in the radial direction is provided at the radial outer side part of the circumferential opening portion of the guide concave groove on the circumferential side surface of the guide wall portion, and a claw portion that is configured to be engaged with the outer radial groove is provided on the outwardly bent plate portion,
an inner radial groove extending in the radial direction is provided at the radial inner side part of the circumferential opening portion of the guide concave groove on the circumferential side surface of the guide wall portion, and a claw portion that is configured to be engaged with the inner radial groove is provided on the inwardly bent plate portion, and
a groove bottom surface of the outer radial groove and a groove bottom surface of the inner radial groove are disposed on the same imaginary cylindrical surface.

9. The opposed piston-type disc brake device according to claim 3, wherein
the connecting plate portion has a notch at an end portion on a side closer to the rotor in the axial direction, and
a part of the resilient portion or a part of the pressing portion is disposed on an inner side of the notch.

10. The opposed piston-type disc brake device according to claim 4, wherein
at least one of the inwardly bent plate portion and the outwardly bent plate portion has a pressure receiving portion that is configured to receive a torque acting on the pad during braking.

11. The opposed piston-type disc brake device according to claim 1, wherein
each of the resilient portion and the pressing portion does not protrude from the axial opening portion of the guide concave groove to a side of the rotor in the axial direction.

12. The opposed piston-type disc brake device according to claim 1, wherein
the resilient portion includes a cutout portion.

13. The opposed piston-type disc brake device according to claim 1, wherein
the pressing portion is configured to press an axial side surface of the lug portion of the pad.
